(19) United States
(12) Patent Application Publication
(10) Pub. No.: US 2010/0128779 A1
(43) Pub. Date: May 27, 2010

(54) METHOD AND APPARATUS FOR SPLICING IN A COMPRESSED VIDEO BITSTREAM

(76) Inventors: Chanchal Chatterjee, Encinitas, CA (US); Robert Owen Eifrig, San Diego, CA (US)

Correspondence Address: GAZDZINSKI & ASSOCIATES, PC, 16644 WEST BERNARDO DRIVE, SUITE 201, SAN DIEGO, CA, 92127, US

(21) Appl. No.: 12/618,293

(22) Filed: Nov. 13, 2009

Related U.S. Application Data
(60) Provisional application No. 61/199,292, filed on Nov. 14, 2008.

(51) Int. Cl. H04N 7/26

(52) U.S. Cl. 375/240.12; 375/240.27; 375/E07.243

(57) ABSTRACT

Methods and apparatus for splicing multiple video streams together. In one embodiment, two compressed video bit streams having one or more disparate qualities, such as bit rate, format, field parity, etc., are spliced together to form a single video bit stream that is free from any significant artifact. In one variant, a splicing boundary is located (e.g., at an I-frame or P-frame of a first stream), and the second stream spliced in at that point. A correction (e.g., addition or deletion of a frame) is then applied. In one implementation, the process maintains compliance with H.264 requirements.

### PRIORITY AND RELATED APPLICATIONS

This application claims priority to co-owned and co-pending U.S. provisional patent application Ser. No. 61/199,292 filed Nov. 14, 2008 entitled “Method and Apparatus for Splicing B Pictures in a Compressed Video Bitstream”, which is incorporated herein by reference in its entirety. This application is related to co-owned and co-pending U.S. patent application Ser. No. 12/322,887 filed Feb. 9, 2009 and entitled “Method and Apparatus for Transrating Compressed Digital Video”, U.S. patent application Ser. No. 12/604,766 filed Oct. 23, 2009 and entitled “Method and Apparatus for Transrating Compressed Digital Video”, U.S. patent application Ser. No. 12/396,393 filed Mar. 2, 2009 and entitled “Method and Apparatus for Video Processing Using Macroblock Mode Refinement”, U.S. patent application Ser. No. 12/604,859 filed Oct. 23, 2009 and entitled “Method and Apparatus for Video Processing Using Macroblock Mode Refinement”, and U.S. patent application Ser. No. 12/582,640 filed Oct. 20, 2009 and entitled “Rounding and Clipping Methods and Apparatus for Video Processing”, the contents of each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates to the field of digital video processing, and more particularly in one exemplary aspect, to methods and systems of splicing video associated with digital video bitstreams.

2. Description of the Related Technology

Since the advent of Moving Pictures Expert Group (MPEG) digital audio/video encoding specifications, digital video is ubiquitously used in today's information and entertainment networks. Example networks include satellite broadcast networks, digital cable networks, over-the-air television broadcasting networks, and the Internet.

Furthermore, several consumer electronics products that utilize digital audio/video have been introduced in the recent years. Some examples included digital versatile disk (DVD), MP3 audio players, digital video cameras, and so on.

Such proliferation of digital video networks and consumer products has led to an increased need for a variety of products and methods that perform storage or processing of digital video. One such example of video processing is changing bitrate of a compressed video bitstream. Such processing may be used to, for example, change bitrate of a digital video program stored on a personal video recorder (PVR) at the bitrate at which it was received from a broadcast video network to the bitrate of a home network to which the program is being sent. Changing bitrate of a video program is also performed in prior art video distribution networks such as digital cable networks or an Internet protocol television (IPTV) distribution network.

The wide spectrum of types of digital video devices has spanned a plethora of specific requirements and use cases. For example, at one extreme of the spectrum lie consumer devices which are meant for mobile personal playback, whereas the other end of the spectrum may include commercial grade theaters. Accordingly, several different advanced codecs of varying capabilities (such as VC-1 and H.264), have found support niches within the electronics community. Many video codecs also support a wide range of bit rates, and features.

The task of splicing (i.e., combining or inserting) video data has become more complex with the introduction of the aforementioned advanced codecs. Splicing of disparate or heterogeneous video streams (for instance, those encoded with different codecs and/or different specifications of the same codec such as different bitrate, GOP structure, and interlace formats) may be desirable, for example, when performing advertisement insertion or bridging media from multiple sources. Furthermore, splicing has wide applicability in video distribution networks such as digital cable or satellite networks, or an internet protocol television (IPTV) distribution network. Unfortunately, splicing data streams from different codec types is not straightforward for many reasons. Some of these reasons are now described in greater detail.

### Video Encoding/Decoding—

As used herein, the term “picture” refers generally and without limitation to a frame or a field. If a frame is coded with lines from both fields, it is termed a “frame picture”. If, on the other hand, the odd or even lines of the frame are coded separately, then each of them is referred to as a “field picture”. Prior art video decoding generally comprises three frame types, Intra pictures (I-pictures), Predictive pictures (P-pictures), and Bi-directional pictures (B-pictures). H.264 allows other types of coding such as Switching I (SI) and Switching P (SP) in the Extended Profile. I-pictures are generally more important to a video codec than P-pictures, and P-pictures are generally more important to a video codec than B-pictures. P-pictures are dependent on previous I-pictures and P-pictures. B-pictures come in two types, reference, and non-reference. Reference B-pictures (Br-pictures) are dependent upon one or more I-pictures, P-pictures, or other reference B-pictures. Non-reference B-pictures are dependent on I-pictures, or P-pictures or reference B-pictures. As a result, the loss of a non-reference B-picture will not affect I-picture, P-picture and Br-picture processing, and the loss of a Br-picture, though not affecting I-picture and P-picture processing, may affect B-picture processing, and the loss of a P-picture, though not affecting I-picture processing, may affect B-picture and Br-picture processing. The loss of an I-picture may affect P-picture, B-picture and Br-picture processing.

Due to the varying importance of these different picture types, video encoding does not proceed in a sequential fashion. Significant amounts of processing power are required to compress and protect I-pictures, P-pictures, and Br-pictures, whereas B-pictures may be “filled-in” afterward. Thus, the video encoding sequence would first code an I-picture, then P-picture then Br-picture, and then the “sandwiched” B-picture. The pictures are decoded in their proper sequence. Herein lies a fundamental issue; i.e., decoding B pictures in a compressed digital video bit stream requires decompressed content from both prior and future frames of the bit stream.

Due to this complex ordering of pictures containing frame and field pictures, reference and non-reference B-pictures, different ordering of top-bottom field parities in interlaced frames, splicing between two streams require a complex set of algorithms that make the transition syntactically legal per the desired “target” video standard (e.g., H.264).

The task of producing a spliced video bitstream that is syntactically conformant to a standard (e.g., H.264), and which exhaustively addresses every possible mode in which pictures may be encoded in the two video bitstreams being spliced, remains unaddressed in the prior art. Prior art solutions for splicing mostly address MPEG-2 encoded video splicing, which does not consist of reference or hierarchical B-pictures, complementary field pairs, non-paired fields, etc. Due to the wider variety of H.264 coding possibilities, the splicing problem between any two arbitrary H.264 streams is quite complex, and completely unaddressed by such prior art solutions.

Hence, there is a need for an improved method and apparatus for splicing video bitstreams which may or may not be heterogeneous in nature, including those having reference B or hierarchical B pictures.

### SUMMARY OF THE INVENTION

The present invention satisfies the foregoing needs by providing improved methods and apparatus for video processing, including splicing of disparate video data streams.

In a first aspect of the invention, a video splicing method is disclosed. In one embodiment, the method comprises: providing a first video stream comprising hierarchical B pictures; providing a second video stream comprising no hierarchical B pictures; identifying a splicing boundary; splicing the first and second streams at the boundary to produce a spliced stream; and applying a correction to the spliced stream. In one variant, the act of identifying is performed so as to maintain compliance with H.264 protocol requirements. In another variant, the act of identifying is performed based at least in part on frame type. The frame type is selected from e.g., (i) I-frames; and (ii) P-frames, and the act of splicing comprises splicing in the second stream at an I-frame or P-frame of the first stream. In another variant, the method further comprises evaluating field parity; e.g., evaluating whether a frame corresponds to a top field or bottom field associated with an interlaced video stream. The splicing boundary is then adjusted based at least in part on the evaluation of parity. In yet another variant, applying a correction comprises duplication of a frame. In a further variant, applying a correction comprises deleting a frame. In still another variant, the method further comprises throttling a bitrate associated with the spliced stream to as to avoid overflow or underflow conditions.

In a second embodiment, the video splicing method comprises: providing a first video stream encoded according to a standard and comprising a first plurality of coding parameters; providing a second video stream encoded according to the same standard and comprising a second plurality of coding parameters, the second plurality of parameters being different from the first plurality of parameters in at least one regard; identifying a splicing boundary; and splicing the first and second streams at the boundary to produce a spliced stream. In one variant, the standard comprises the H.264 standard.

In a second aspect of the invention, video splicing apparatus is disclosed. In one embodiment, the apparatus comprises: first apparatus adapted to receive a first video stream comprising hierarchical B pictures; second apparatus adapted to receive a second video stream comprising no hierarchic B pictures; logic in communication with the first and second apparatus, the logic configured to identify a splicing boundary within at least one of the first and second streams; a splicer configured to splice the first and second streams at the boundary; and logic configured to apply a correction. In one variant, the apparatus is configured to maintain compliance with H.264 protocol requirements. In another variant, the logic configured to identify is configured to identify based at least in part on frame type selected from e.g.,: (i) I-frames; and (ii) P-frames. In another variant, the splicer comprises logic adapted to splice in the second stream at an I-frame or P-frame of the first stream. In a further variant, the apparatus further comprises logic in communication with the splicer and configured to evaluate field parity (e.g., whether a frame corresponds to a top field or bottom field associated with an interlaced video stream). In still another variant, the apparatus further comprises logic in communication with the splicer and configured to adjust the splicing boundary based at least in part on the evaluation of parity. In another variant, the apparatus further comprises logic adapted to apply a correction via duplication or deletion of a frame. In yet another variant, the apparatus further comprises apparatus configured to throttle a bitrate associated with the spliced stream to as to avoid overflow or underflow conditions. The apparatus configured to throttle comprises e.g., first and second picture buffers, and at least one of the buffers is configured to be emptied at a substantially constant rate specified by a presentation timeline. In another variant, the video splicing apparatus comprises a processor and at least one computer program adapted to run thereon, the at least one computer program comprising at least: (i) the logic configured to identify a splicing boundary within at least one of the first and second streams; (ii) the splicer; and (iii) the logic configured to apply a correction.

In a third aspect of the invention, computer readable apparatus is disclosed. In one embodiment, the apparatus comprises a storage medium, the medium adapted to store at least one computer program, the at least one computer program being configured to, when executed on a processing device: receive a first video stream comprising a first type of picture, the first type having a first form of dependency relating to frame type; receive a second video stream comprising a second type of picture, the second type having a second form of dependency relating to frame type different than the first form; identify a splicing boundary within the first stream; splice the second stream into the first at the boundary to produce a spliced stream; and determine whether a correction is required and if so, apply a correction.

In a fourth aspect of the invention, a splicing system is disclosed. In one embodiment, the system comprises a first video stream source, a second video stream source, and a splicing apparatus. In one embodiment, the two streams comprise H.264 encoded streams having pictures containing frame and field pictures and reference and non-reference B-pictures, and the splicer is adapted to splice the two streams.

### BRIEF DESCRIPTION OF THE DRAWINGS

FIG. 1a is a block diagram of the Hypothetical Reference Decoder (HRD) Model in Annex C of the H-1.264 Standard.

FIG. 1b is a graphical illustration of PTS and DTS time stamps of a sequence in display and encoding orders.

FIG. 2 is a graphical illustration of hierarchical splicing of three streams according to one embodiment of the invention.

FIG. 3 is a logical flow diagram illustrating one embodiment of a generalized method for splicing data sequences with no hierarchic B frames according to the invention.

FIG. 4 is a logical flow diagram illustrating one embodiment of a generalized method for splicing data sequences having hierarchic B frames, according to the invention.

FIG. 4a is a logical flow diagram illustrating one embodiment of a method of deleting an extra picture at a splice point, in accordance with the present invention.

FIG. 4b is a logical flow diagram illustrating one embodiment of a method of splicing sequences of different hierarchies and filling gaps, in accordance with the present invention.

FIG. 4c is a logical flow diagram illustrating one embodiment of a method of filling gaps under differing circumstances, in accordance with the present invention.

FIG. 5 is a block diagram showing an exemplary sequence of video pictures for 2-3 pull-down display, in accordance with an embodiment of the present invention.

FIG. 6 is a block diagram showing an exemplary sequence of video pictures showing a two-level hierarchy of B pictures, in accordance with an embodiment of the present invention.

FIG. 7 is a block diagram of an exemplary implementation of a splicing and transrating apparatus in accordance with an embodiment of the invention.

All figures and tables © Copyright 2008-2009 TransVideo, Inc. All rights reserved.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

As used herein, “video bitstream” refers without limitation to a digital format representation of a video signal that may include related or unrelated audio and data signals.

As used herein, “transrating” refers without limitation to the process of bit-rate transformation. It changes the input bit-rate to a new bit-rate which can be constant or variable according to a function of time or satisfying a certain criteria. The new bitrate can be user-defined, or automatically determined by a computational process such as statistical multiplexing or rate control.

As used herein, “transcoding” refers without limitation to the conversion of a video bitstream (including audio, video and ancillary data such as closed captioning, user data and teletext data) from one coded representation to another coded representation. The conversion may change one or more attributes of the multimedia stream such as the bitrate, resolution, frame rate, color space representation, and other well-known attributes.

As used herein, the term macroblock (MB) refers without limitation to a two dimensional subset of pixels representing a video signal. A macroblock may or may not be comprised of contiguous pixels from the video and may or may not include equal number of lines and samples per line. A preferred embodiment of a macroblock comprises an area 16 lines wide and 16 samples per line.

As used herein, the term H.264 refers without limitation to ITU-T Recommendation No. H.264, “SERIES H: AUDIOVISUAL AND MULTIMEDIA SYSTEMS—Infrastructure of audiovisual services—Coding of moving Video—Advanced video coding for generic audiovisual services” dated November 2007, and any variants (e.g., H.264 SVC), revisions, modifications, or subsequent versions thereof, each of which is incorporated by reference herein in its entirety.

### Overview

In one salient aspect, the present invention discloses methods and apparatus for splicing two (or more) video streams together. The invention resolves the issues inherent to splicing two compressed video bit streams (having one or more disparate qualities, such as bit rate, format, field parity, etc.), together to form a single video bit stream. Splicing according to various embodiments of the invention can also be hierarchical in nature.

In one embodiment of the invention, two video streams are spliced together—one containing certain types of pictures (e.g., hierarchic B pictures), and the other without them. A splicing boundary is determined in compliance with e.g., extant protocol requirements. In a first implementation, the boundaries are determined based on frame types. One or more additional constraints (e.g. field parity, bit rate) are considered and, a correction (e.g., duplication of a frame, and/or deletion of a frame) is applied.

The splicing boundary can be determined based on the decoding requirements of the frame types. For example, an I-picture has no decoding requirements, as it is decoded “standalone”. In contrast, a B-picture requires information from both its lead-pictures and its follow-pictures. A P-picture only relies on the information from its lead-pictures. Accordingly, a first video stream may be spliced at either an I-frame or a P-frame. The spliced-in second video stream replaces the spliced frame (e.g., the P-frame of the first stream) with its own replacement I-frame, thus prompting the video decoder to begin freshly decoding the second stream.

One or more additional constraints may also be considered, such as the current field parity, or bit rate. For example, in some “interlaced” video codecs, each frame additionally has “top/bottom parity”. Interlaced video flashes only half the frame at a time. A “field” is an image that contains only half of the lines needed to make a complete picture. The top field comprises every other row of an image, starting at the first row (e.g., 1, 3, 5, etc.). The bottom field comprises every other row of an image, starting at the second row (e.g., 2, 4, 6, etc.). The top field and bottom field are interlaced to produce the complete image without requiring the full bandwidth to do so. Each frame of an interlaced video is assigned “parity”, this parity indicating if the frame is a top or bottom field. Parity must always alternate; i.e., a top frame must always be followed by a bottom frame, and vice versa.

Thus, in one implementation, a first video stream which is spliced at a P-field during a bottom parity field is repeated for a stalling top parity field. The spliced-in second video stream replaces the subsequent field (e.g., the bottom parity P-field of the first stream) with its own replacement bottom parity I-field, thus prompting the video decoder to begin freshly decoding the second stream while remaining consistent with the correct parity sequence.

In another aspect of the invention, the output is throttled according to the input and output video bit streams to resolve any data rate discrepancies. In a first embodiment, two regulated buffers (a Compressed Picture Buffer (CPB) and a Display Picture Buffer (DPB)) are described for a hypothetical reference decoder (HRD). The CPB is at the input of the HRD and is used to regulate network jitter and outgoing compressed bitrate. The DPB is at the output of the HRD and is used to store decoded pictures before they are displayed.

If there is a difference in the bitrates of two spliced streams and there is a difference in the CPB fullness at the spliced point, then blindly switching from one stream to the other can cause HRD CPB and DPB overflow or underflow without correction.

Consequently, one rate matching apparatus is a CPB which accumulates or loses bits due to the addition or deletion of frames or fields. These quantities are measured in field units (i.e., a frame comprises a top filed and bottom field). Thus, if a field is added to the CPB, the running count is incremented by one; if an extra frame is added, it is incremented by two. Likewise, if a frame is deleted from the CPB, the running count is decremented by two. During splicing, the CPB must operate within reasonable limits (which may vary depending on device operational memory capabilities).

The DPB is in one implementation emptied at a constant time interval specified by the presentation timeline. Positive changes to the DPB denote delays from the intended or ideal presentation time. Negative changes indicate that the picture is presented earlier than intended. Ideally, the splicer should not cause significant deviations to the DPB.

### DESCRIPTION OF EXEMPLARY EMBODIMENTS

Exemplary embodiments of the various apparatus and methods according to the present invention are now described in detail.

It will be recognized that while the exemplary embodiments of the invention are described herein primarily in the context of the H.264 codec syntax referenced above, the invention is in no way so limited, and in fact may be applied broadly across various different codec paradigms and syntaxes.

Moreover, it will be recognized that any tables contained herein are purely illustrative in nature, and not representative of actual images or relationships between frames or other elements (e.g., sizing and width variations in no way indicate any relative differences).

One common architectural concept underlying certain aspects and embodiments of the invention relates to use of a “three stage” process—i.e., (i) an input processing stage, (ii) an intermediate format processing stage, and (iii) an output processing stage. In one embodiment, the input processing stage comprises both a decompression stage that takes an input bitstream and produces an intermediate format signal, and a parsing stage that parses certain fields of the bitstream to make them available to the output processing stage.

The intermediate format processing stage performs signal processing operations, described below in greater detail, in order to condition the signal for transrating.

Finally, the output processing stage converts the processed intermediate format signal to produce the output bitstream, which comprises the transrated version of the input bitstream in accordance with one or more quality metrics such as e.g., a target bitrate and/or a target quality.

### Hypothetical Reference Decoder and Splicing Scenarios—

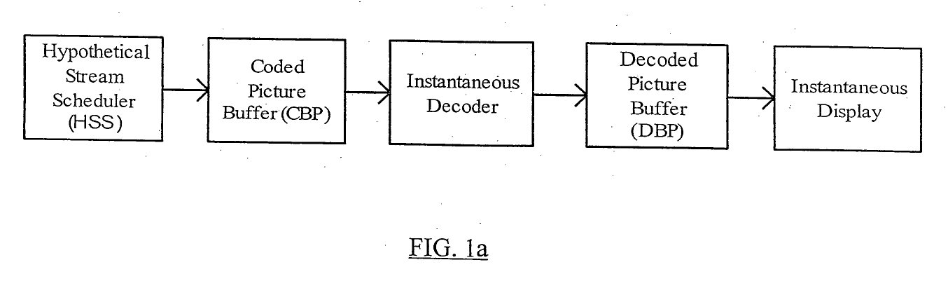

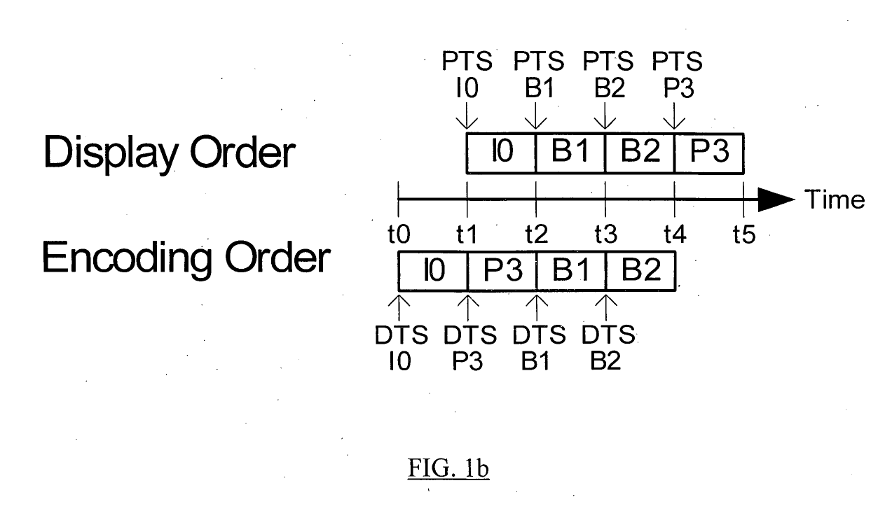

Annex C of the H.264 standard (ITU-T Recommendation No. H.264, “SERIES H: AUDIOVISUAL AND MULTIMEDIA SYSTEMS—Infrastructure of audiovisual services—Coding of moving Video—Advanced video coding for generic audiovisual services” dated November 2007, which is incorporated by reference herein in its entirety) describes a hypothetical reference decoder (HRD) consisting of a Hypothetical Stream Scheduler (HSS), Coded Picture Buffer (CPB), instantaneous decoder, Decoded Picture Buffer (DBP), and instantaneous display, in that order. See FIG. 1a.

Appendix I herein lists various abbreviations and acronyms used in the following discussion.

The HRD model of AVC and Video Buffering Verifier (VBV) model of MPEG-2 specify a Decode Time Stamp (DTS) (aka tᵣ(n)), which indicates the time at which an encoded picture or audio block (access unit) is instantaneously removed from the CPB and decoded by the instantaneous decoder. It also specifies a Presentation Time Stamp (PTS) (aka t_{o,dpb}(n)), which indicates the instant at which an access unit is removed from the DPB and presented for instantaneous display. FIG. 1b graphically illustrates PTS and DTS time stamps of a sequence in display and encoding orders.

For the exemplary embodiments of splicing discussed herein, it is assumed that the CPB does not overflow due to accumulation of bits respectively, and do not underflow due to deletion of bits respectively

Also, it is assumed for purposes of certain embodiments herein that any deletion of frames is achieved by setting the no_output_of_prior_pics_flag in the immediately next IDR frames in display order in its slice header in the dec_ref_pic_marking( ) syntax. This frame is an IDR frame. Furthermore, it is assumed that the DTS of the IDR frame is less than the PTS of the frame to be deleted, and greater than or equal to the prior (possibly B) frame not to be deleted.

In order to delete frame P3 only by setting the no_output_of_prior_pics_flag in the slice header of IDR4, the PTS and DTS timings have to satisfy the following inequality:

PTS(B2)≦DTS(IDR4)<PTS(P3) Eqn. (1)

The following scenarios which may be encountered during video splicing are now considered in detail.

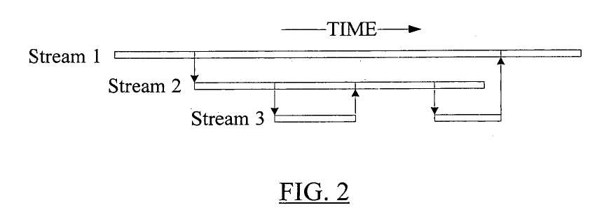

As previously noted, splicing according to various embodiments of the invention can be hierarchical in nature. For example, considering three hypothetical streams (streams 1, 2 and 3), stream 2 can be spliced into stream 1, and then soon after stream 3 can be spliced into stream 2. Subsequently, we can return to stream 2 and eventually to stream 1. FIG. 2 herein graphically illustrates this relationship.

Scenario No. 1—Sequences with No Hierarchic B Frames—

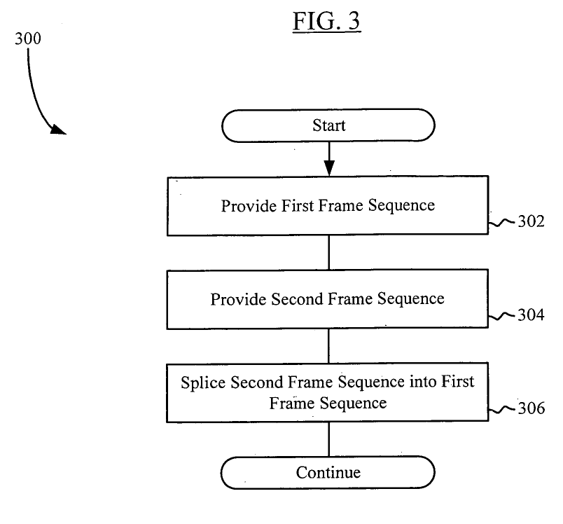

FIG. 3 illustrates one embodiment of a generalized method for splicing data sequences with no hierarchic B frames according to the invention. As shown in FIG. 3, the method 300 comprises providing a first frame sequence (step 302), providing a second frame sequence (step 304), and splicing the two sequences together (step 306), such as by splicing the second sequence into the first. It will be appreciated that the terms “first” and “second” are purely relative, and connote no particular sequence or hierarchy of streams or sequences.

As a specific example of the foregoing generalized methodology 300, the following sequence (Seq1) with frame pictures only with SubGop=3 and no hierarchic B frames in the display (D) and Coding (C) order is considered. The sequence has SubGop=3, Hierarchy=0 and Latency=1.

TABLE 1
Seq1: Frame Sequence with SubGop = 3, Hierarchy = 0, and Latency = 1.

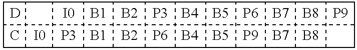

The sequence has a latency of 1 frame; i.e., the decoded frames are displayed one frame after the encoding begins Now another sequence (Seq2) with SubGop=4 and no hierarchic B frames is considered. It has SubGop=4, Hierarchy=0 and Latency=1.

TABLE 2
Seq2: Frame Sequence with SubGop = 4, Hierarchy = 0, and Latency = 1.

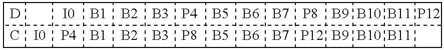

The two sequences Seq1 and Seq2 are then spliced, with Seq1 first and Seq2 spliced in (Table 3), and Seq2 first with Seq1 spliced in (Table 4), where the spliced sequence is shown in bold.

TABLE 3
Seq1 Followed by Spliced Seq2 has Latency = 1.

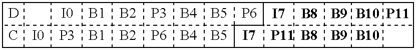

TABLE 4
Seq2 Followed by Spliced Seq1 has Latency = 1.

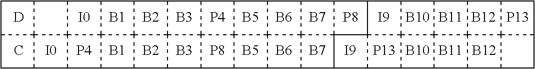

Note that in all these frame sequences and the spliced sequences, the latency and hierarchy remain the same (at one in this example). Note also that the arbitrary number of B pictures in the SubGop may change across the splice point.

Scenario No. 2—Sequences with Hierarchic B Frames—

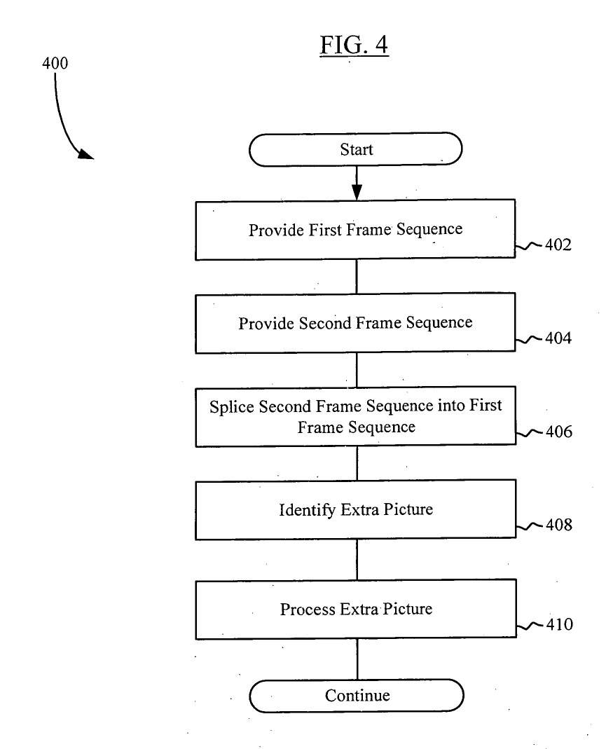

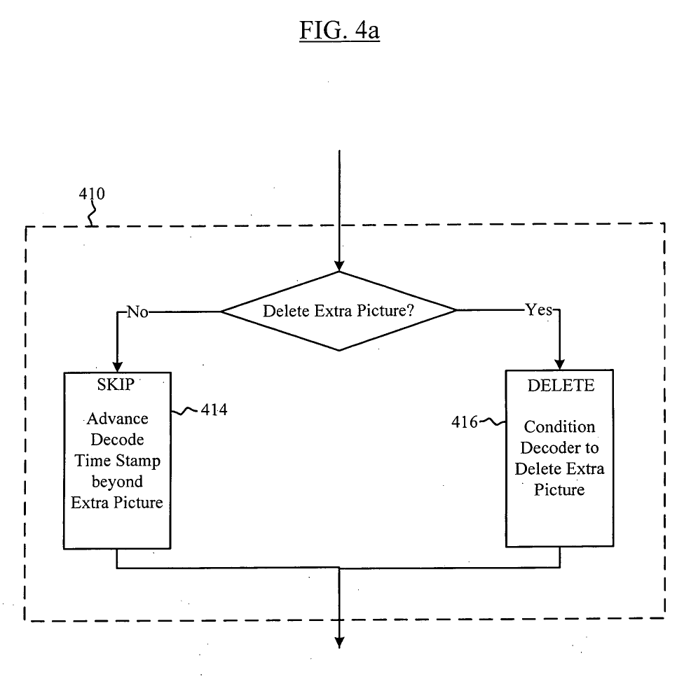

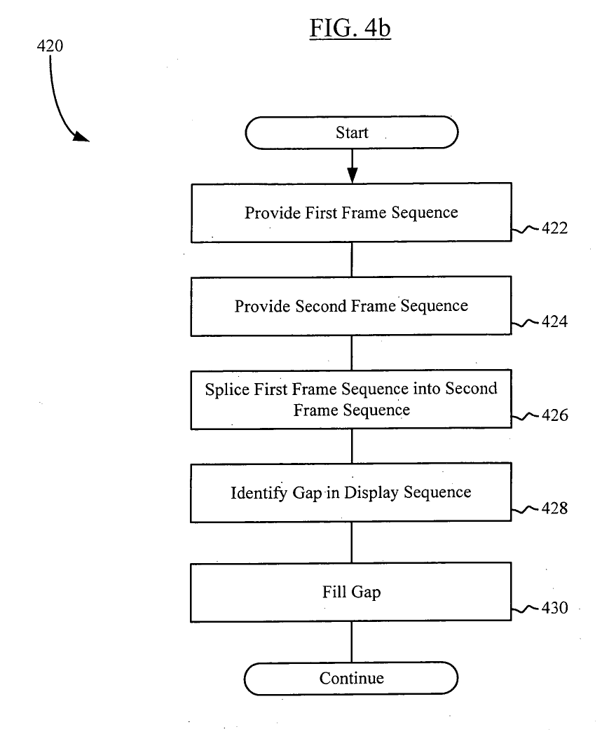

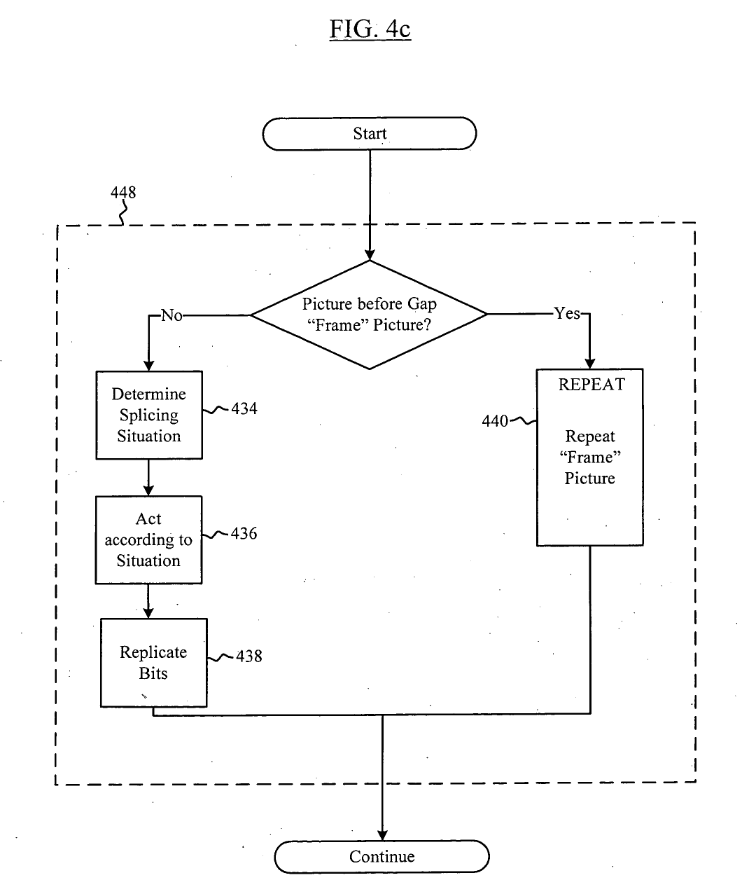

FIG. 4 illustrates one embodiment of a generalized method for splicing data sequences having hierarchic B frames, according to the invention.

As shown in FIG. 4, the method 400 comprises providing a first frame sequence (step 402), providing a second frame sequence (step 404), and splicing the two sequences together (step 406), such as by splicing the second sequence into the first. Next, an extra frame is identified (step 408), and the extra frame processed (step 410).

Next a frame sequence (Seq3) is examined with SubGop=4 with one hierarchic B frame per SubGop, in decoding and encoding order. Here, SubGop=4, Hierarchy=1 and Latency=2.

TABLE 5
Seq3: Frame Sequence with SubGop = 4, Hierarchy = 1, and Latency = 2.

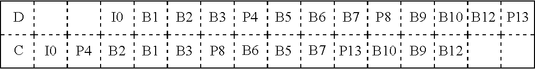

Here, the latency is 2; i.e., the decoded frames are displayed two frames after the encoding begins. It is also noted that for frame sequences:

Latency=Levels of Hierarchy+1 Eqn. (2)

Now, a splice of a Hierarchy=0 sequence (such as Seq1 or Seq2) with a Hierarchy=1 sequence (such as Seq3), i.e., Seq3 followed by Seq1 or Seq2 is attempted.

TABLE 6
Seq3 Followed by Spliced Seq1.

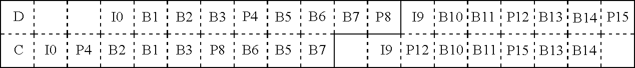

TABLE 7
Seq3 Followed by Spliced Seq2.

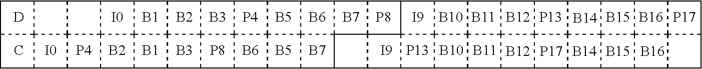

Note that in both cases of splicing above (Table 6 and Table 7), the display sequence has an extra picture at the splice point which can be deleted and not displayed. The extra frame in both Tables is P8. This can be accomplished by e.g., one of the two methods below:
1. “DELETE” option—Setting the no_output_of_prior_pics_flag for the subsequent IDR picture (i.e., I9) in its slice header in the dec_ref_pic_marking( ) syntax. This strategy works if the decoding time of I9 is greater than or equal to presentation time of B7, but less than the presentation time of P8. This condition tells the decoder that only P8 is to be deleted. The condition is represented by Eqn. (3):
2.

PTS(B7)≦DTS(I9)<PTS(P8) Eqn. (3)
This timing is signaled to the decoder either via the picture timing SEI message (with CpbDpbDelaysPresentFlag equal to 1), or via the PTS/DTS if the AVC elementary stream is encapsulated in a MPEG2 transport stream.
3. “SKIP” option—Do not delete P8, and advance the DTS of I9 by 2 frames with respect to DTS of B7 per Eqn. (4):

DTS(I9)=DTS(B7)+2*T_{frame} Eqn. (4)
(where T_{frame} is one frame period)

The foregoing logic is graphically illustrated in steps 414 and 416 of the method of FIG. 4a.

Next, a Hierarchy=1 sequence (such as Seq3) is spliced with a Hierarchy=0 sequence (such as Seq1 or Seq2), i.e., Seq1 or Seq2 followed by Seq3:

TABLE 8
Seq1 Followed by Spliced Seq3.

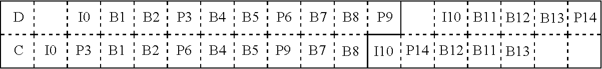

TABLE 9
Seq2 Followed by Spliced Seq3.

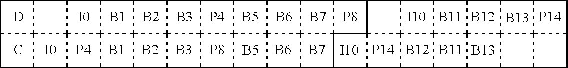

The foregoing logic is graphically illustrated in the generalized methodology of FIG. 4b herein. As shown in FIG. 4b, the method 420 comprises providing a first frame sequence (step 422), providing a second frame sequence (step 424), and splicing the two sequences together (step 426), such as by splicing the second sequence into the first. Next, a gap is identified (step 428), and the gap filled (step 430).

In the two cases of splicing above, wherein a Hierarchy=1, Latency=2 sequence is spliced into a Hierarchy=0, Latency=1 sequence, a gap in the display sequence that needs to be filled in with the previous frame which in this case corresponds to P9 or P8. This can be achieved in one embodiment of the invention as follows:
1. For frame pictures, add or modify the pic_struct field of the picture timing SEI (see, e.g., H.264 Annex D1.2 and D2.2, reproduced as Appendix II and III herein) for P8 or P9 in order to make the frame repeat upon display. For example, when P9 or P8 is a frame picture, pic_struct=7 makes the frame repeat on display.
2. For field pictures, a field cannot be repeated. In this case, different methods (based on the exemplary splicing situation as discussed in the following sections) are employed; e.g., including copying the bits of the field.

Steps 434-440 of the method of FIG. 4c herein graphically illustrate the foregoing exemplary embodiment of the gap processing logic.

In splicing sequences, in addition to the addition/deletion/no action of pictures to maintain continuity in the display sequence, field parity needs to be maintained. This can be demonstrated with the following field sequence with Hierarchy=0, Latency=1, and SubGop=3:

TABLE 10
Seq4: Field Sequence with SubGop = 3, Hierarchy = 0, and Latency = 1.

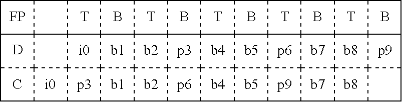

Here, FP denotes field parity of the display sequence which is either top (T) field or bottom (B) field. Consider the following sequence with different field parity.

TABLE 11
Seq5: Field Sequence with SubGop = 3, Hierarchy = 0, and Latency = 1.

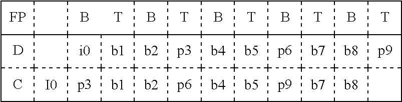

If Seq4 is spliced with Seq5 even without change of hierarchy/latency, a problem results due to field parity mismatch at the splice point.

TABLE 12
Field Parity Mismatch in Seq4 Followed by Spliced Seq5.

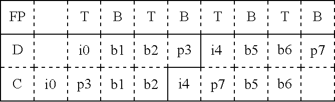

In Table 12, it can be seen that two bottom fields are next to each other for p3 and i4, which is illegal. In order to solve this problem, a replication is performed (shown in gray) for bottom field p3 as a top field p3 in the bitstream.

TABLE 13
Matched Field Parity in Seq4 Followed by Spliced Seq5.

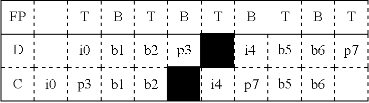

### Repeat a Picture—

A distinction can be made between repeating a picture and replicating the bits in a picture. Repeating a picture is applicable only for frame pictures, whereby the frame is repeated by using the pic_struct field of the picture timing SEI. The cases for pic_struct are given in Annex D of the H.264 standard (see Appendix III hereto):
1. pic_struct=5: repeat an interlaced frame picture (TB or BT parity) as TBT, i.e., top, bottom, top field in that order.
2. pic_struct=6: repeat an interlaced frame picture (TB or BT parity) as BTB, i.e., bottom, top, bottom field in that order.
3. pic_struct=7: repeat an interlaced frame picture (TB or BT parity) with same panty.
4. pic_struct=8: repeat an interlaced frame picture (TB or BT parity) with same parity twice.

Replication of bits is discussed in detail below.

### Replication of Bits in a Picture—

Replication of a picture means copying the bits of a picture in the bitstream. This is different from repeating a picture by using picture timing SEI, which is not allowed for field pictures. Replication of a picture may produce a different number of bits in the new picture.
1. For replication of I field picture as an I field:
   a. all bits are copied,
   b. assign new poc number, frame number,
   c. change field parity if necessary,
   d. assign new PTS, DTS for the new field picture.
2. For replication of P field picture as a P field:
   a. for intra macroblocks, copy all bits,
   b. for predicted macroblocks, make mv=0, refIdx=0 (may be skipped), where L0 List refIndex=0 is the picture being replicated,
   c. assign new poc number, frame number,
   d. change field parity if necessary,
   e. assign new PTS, DTS for the new field picture.

### Consistent and Inconsistent Parity—

The illustrated embodiment makes use of the concept of field parity transitions across the splicing boundary being consistent or inconsistent. If the original sequence ends with a field parity (say T=top), and the spliced sequence starts with the opposite field parity (say B=bottom), that is labeled as consistent across the splice boundary, since the expected field parity for the next field is B=bottom. On the other hand, if the original sequence ends with a T=top field parity and the spliced sequence starts with T=top field parity, then we term it inconsistent parity, since this parity is different from the expected field parity.

For example, a frame sequence I0 B1 B2 P3 which is TB parity, i.e., top field first, when spliced with a frame sequence I0 B1 B2 P3 that has TB parity, a consistent parity results. If the spliced sequence has BT parity, i.e., bottom field first, then the parity is inconsistent. For a field sequence i0(T) b1(B) b2(T) p3(B), when spliced with a sequence i0(T) b1 (B) b2(T) p3(B), it is a consistent parity. If it is spliced with a sequence i0(B) b1(T) b2(B) p3(T), it is an inconsistent parity.

### Splicing Constraints—

The examples above, demonstrate the need for the following conditions to create a legal H.264 bitstream after splicing:
1. Maintain continuity in the decoded sequence across the splice point such that there no missing or extra pictures to display.
2. Maintain field parity consistency for field and frame pictures across the splice point.
3. Over many splices, the changes in the CPB and DPB are managed (discussed later) such that they do not deviate an undesirable amount from the original sequence timing.

### Enumeration of Splicing Examples—

In the next sections, the different splicing scenarios are described. In each case, the hierarchy of the original and spliced sequences is defined, as well as the field parity of the original and spliced sequences. The cases considered are:
1. Frame and field sequences and splicing between them, i.e.,
   a. Frame sequence followed by spliced Frame sequence,
   b. Field sequence followed by spliced Field sequence,
   c. Frame sequence followed by spliced Field sequence, and
   d. Field sequence followed by spliced Frame sequence.
2. In each case, Hierarchy=0 and Hierarchy=1 are considered.
3. In each case, field parity that is consistent and inconsistent at the splice point is considered.

### Assumptions—

The following assumptions are made in the context of the exemplary embodiments described below:
1. Hierarchy=0 or 1 only.
2. Sequences have SubGops consisting of a string of B's followed by a P or I picture in display order.
3. Time taken to decode a frame is T_{frame}.
4. Time taken to decode a field is T_{field}.
5. The DTS of the pictures in the coded sequence and the PTS of the pictures in the display sequence are separated by integral units of T_{field} in a common time base.
6. In order to repeat frames, the picture timing SEI messages must be used. Thus, for splicing purposes, pic_struct_present_flag is set in the video usability information (VUI) parameters of the SPS parameter set.

### Notations Used in Enumeration of Splicing Examples—

The following notations are used herein for convenience, yet are in no way intended as limiting on the various embodiments or implementations of the invention:
1. Hierarchy=0 means no hierarchic B picture.
2. Hierarchy=1 means a single level of hierarchic B picture.
3. Parity=T means the field picture is a top field.
4. Parity=B means the field picture is a bottom field.
5. Parity=TB means the frame picture has 2 fields with top field first followed by bottom field.
6. Parity=BT means the frame picture has 2 fields with bottom field first followed by top field.
7. Parity=TBT means the frame picture has 3 fields with top field followed by bottom field followed by top field.
8. Parity=BTB means the frame picture is 3 fields with bottom field followed by top field followed by bottom field.
9. Dotted lines represent picture boundaries.
10. Solid bold lines are splice boundaries.
11. A diagonal grid box denotes newly added picture by repeating or replication as discussed above.
12. A horizontal grid box in the display sequence denotes a newly deleted picture.
13. A set of shaded gray boxes in the display sequence denotes a 3 field picture generated with picture timing SEI message pic_struct=5 or 6.
14. A box with “−” in it for the display sequence represents a newly added field.
15. A blank box in the coded sequence denotes no action by the decoder.
16. A box containing “X” in it in the coded sequence denotes deleted time slot.
17. T_{frame}=time needed to decode or display a frame picture.
18. T_{field}=time needed to decode or display a field picture.
19. FP denotes field parity of the display sequence.
   For each splicing case, the actions required by one exemplary embodiment of the splicer of the invention are described in detail.

### CPB, DPB, and Presentation Timeline—

For each splicing case, the CPB may accumulate or lose bits due to addition or deletion of pictures. These quantities are measured in field units; i.e., if an extra field is added to the CPB, it is +1, if extra frame is added, it is +2, if a frame is deleted, it is −2. One goal, during splicing, is to not let the CPB grow out of bounds and maintain this buffer within reasonable limits. The sequence will not be compliant of the CPB over-/under-flows.

The DPB change in the following sections denotes a change in the presentation timeline or schedule. Positive changes denote delays from the intended or ideal presentation time. Negative changes are earlier than intended presentation. The DPB over/underflow (nothing to present, or presentation too far in the future resulting in no space to decode picture at specified DTS) does not occur if encoder provides HDR legal bitstreams. The splicer, however, ensures that the display process can continue at the specified constant frame rate given in the VUI across the splice “seam” where a discontinuity in DPB fullness may occur. In other words, the splice cannot result in gaps in display time or delay presenting the spliced sequence from being able to decode at the designated DTS time. Note that if the cumulative DPB change becomes too positive, the splicer can/must delete a full sub-gop. Note that sub-gops are dense and contiguous in both display and coding order.

It is noted that the CPB and DPB change due to splice in and splice out in each pair of cases. If the CPB or DPB grows, they can be reduced by deleting an entire subgop so that the buffers are bounded. The CPB changes can be further bounded by (1) transrating, and (2) slower or faster than modulation for CBR splicing.

### Field Pictures—Complementary Field Pair and Non-Paired Fields—

For splicing with field pictures, two cases exist according to the exemplary H.264 standard:

1. Complementary field pairs:
a. fields are consecutive in the bitstream in coding and display order,
b. of opposite parity,
c. have same fieldnum,
d. stored in same DPB buffer,
e. are both reference or both non-reference pictures,
f. if reference pictures, second field can not be IDR or have MMCO=5.

2. Non-paired field pictures:
a. field picture not part of complementary field pair,
b. occupies its own DPB slot—uses a full frame of DPB,
c. can not be used as ref for frame pictures,
d. non-consecutive field in coding order,
e. one field can be reference and the other can be non-reference.
   In the splicing discussions below, all field cases are considered first as non-paired field pictures, and then as complementary field pairs.

Frame Sequence Followed by Spliced Frame Sequence—

1. Hierarchy original=0, Hierarchy spliced=0, Parity=Consistent—

TABLE 14

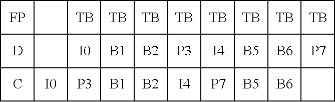

Splicer action: None.

### Presentation Timeline Change=0.

### CPB Change=0.

2. Hierarchy original=0, Hierarchy spliced=0, Parity=Inconsistent—

TABLE 15

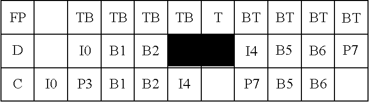

Splicer action:
1. Convert P3 to a 3 field picture that is TBT using pic_struct=5 in picture timing SEI of P3.
2. DTS(P7)=DTS(I4)+T_{frame}+T_{field}.

### Presentation Timeline Change=+1.

### CPB Change=+1.

3. Hierarchy original=0, Hierarchy spliced=1, Parity=Consistent—

TABLE 16

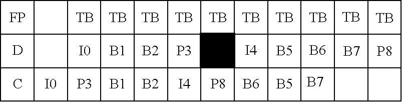

Splicer action:

1. Repeat P3 by using pic_struct=7 in picture timing SEI of P3.

### Presentation Timeline Change=+2.

### CPB Change=+0.

4. Hierarchy original=0, Hierarchy spliced=1, Parity=Inconsistent—

TABLE 17

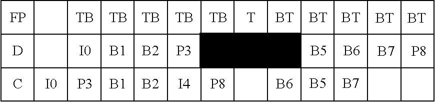

Splicer action:
1. Repeat P3 by using pic_struct=7 in picture timing SEI of P3.
2. Convert I4 to a 3 field picture that is TBT using pic_struct=5 in picture timing SEI of I4.
3. DTS(B6)=DTS(P8)+T_{frame}+T_{field}.

### Presentation Timeline Change=+3.

### CPB Change=+1.

5. Hierarchy original=1, Hierarchy spliced=0, Parity=Consistent—

TABLE 18

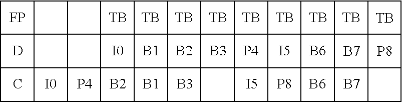

Splicer action:

1. DTS(I5)=DTS(B3)+2*T_{frame}.

### Presentation Timeline Change=+0.

### CPB Change=+2.

This splicing can alternatively be performed as below.

TABLE 19

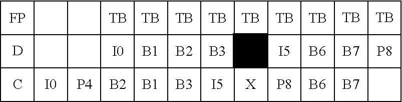

Splicer action:
1. Delete P4 by setting the no_output_of_prior_pics_flag for the subsequent IDR picture, i.e., I5 in its slice header in the dec_ref_pic_marking( ) syntax. Note that here, PTS(B3)≦DTS(I5)<PTS(P4), which satisfies equation (1).

### Presentation Timeline Change=−2.

### CPB Change=−2.

6. Hierarchy original=1, Hierarchy spliced=0, Parity=Inconsistent—

TABLE 20

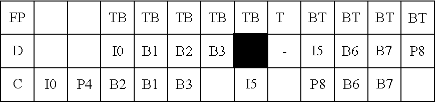

Splicer action:
1. Convert P4 to a 3 field picture that is TBT using pic_struct=5 in picture timing SEI of P4.
2. DTS(I5) DTS(B3)+2*T_{frame}.
3. DTS(P8) DTS(I5) T_{frame}+T_{field}.

### Presentation Timeline Change=+1.

### CPB Change=+3.

This splicing can alternatively be performed as below.

TABLE 21

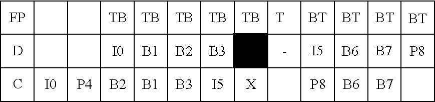

Splicer action:
1. Delete P4 by setting the no_output_of_prior_pics_flag for the subsequent IDR picture, i.e., I5 in its slice header in the dec_ref_pic_marking( ) syntax. Here, PTS(B3)≦DTS(I5)<PTS(P4).
2. Convert B3 to a 3 field picture that is TBT using pic_struct=5 in picture timing SEI of B3.
3. DTS(P8)=DTS(I5)+T_{frame} T_{field}.

### Presentation Timeline Change=−1.

### CPB Change=−1.

7. Hierarchy original=1, Hierarchy spliced=1, Parity=Consistent—

TABLE 22

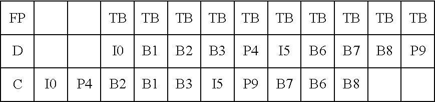

Splicer action: None.

### Presentation Timeline Change=0.

### CPB Change=0.

8. Hierarchy original=1, Hierarchy spliced=1, Parity=Inconsistent—

TABLE 23

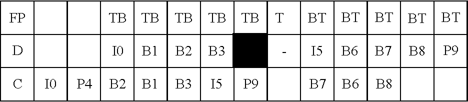

Splicer action:
1. Convert P4 to a 3 field picture that is TBT using pic_struct=5 in picture timing SEI of P4.
2. DTS(B7)=DTS(P9) T_{frame}+T_{field}.

### Presentation Timeline Change=+1.

### CPB Change=+1.

CPB and Presentation Timeline Changes Due to Splice in Followed by Splice Out—

1. Hierarchy original=0, Hierarchy spliced=0, Parity=Consistent:

Total Presentation Timeline Change=0.

Total CPB Change=0.

2. Hierarchy original=0, Hierarchy spliced=0, Parity=Inconsistent:

Total Presentation Timeline Change=+1+1=+2.

Total CPB Change=+1+1=+2.

3. Hierarchy original=0(1), Hierarchy spliced=1(0), Parity=Consistent:

Total Presentation Timeline Change=+2+0(−2)=+2(+0).

Total CPB Change=+0+2(2)=+2(−2).

4. Hierarchy original=0(1), Hierarchy spliced=1(0), Parity=Inconsistent:

Total Presentation Timeline Change=+3+1(1)=+4(+2).

Total CPB Change=+1+3(−1)=+4(+0).

5. Hierarchy original=1, Hierarchy spliced=1, Parity=Consistent:

Total Presentation Timeline Change=0.

Total CPB Change=0.

6. Hierarchy original=1, Hierarchy spliced=1, Parity=Inconsistent:

Total Presentation Timeline Change=+1+1=+2.

Total CPB Change=+1+1=+2.

Non-Paired Field Sequence Followed by Spliced Non-Paired Field Sequence—

1. Hierarchy original=0, Hierarchy spliced=0, Parity=Consistent—

TABLE 24

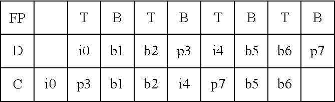

Splicer action: None.

### Presentation Timeline Change=0.

### CPB Change=0.

2. Hierarchy original=0, Hierarchy spliced=0, Parity=Inconsistent—

TABLE 25

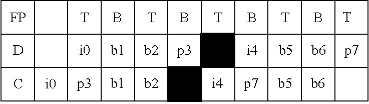

Splicer action:
1. Replicate the bits of bottom field p3 as a top field p3 as described previously herein (see section entitled “Replication of Bits in a Picture”)
2. DTS(replicated p3)=DTS(b2)+T_{field}.
3. DTS(i4)=DTS(replicated p3) T_{field}.

### Presentation Timeline Change=+1.

### CPB Change=+1.

3. Hierarchy original=0, Hierarchy spliced=1, Parity=Consistent—
See “Remaining Splicing Cases Involving Non-Paired Field Sequences” discussed subsequently herein.
4. Hierarchy original=0, Hierarchy spliced=1, Parity=Inconsistent—
See “Remaining Splicing Cases Involving Non-Paired Field Sequences” discussed subsequently herein.
5. Hierarchy original=1, Hierarchy spliced=0, Parity=Consistent—

TABLE 26

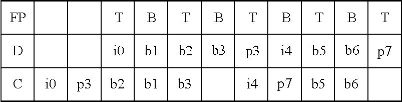

Splicer action:

1. DTS(i4)=DTS(b3)+2*T_{field}.

### Presentation Timeline Change=+0.

### CPB Change=+1.

This can alternatively be spliced as:

TABLE 27

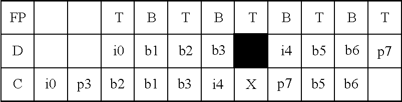

Splicer action:
1. Delete p3 by setting the no_output_of_prior_pics_flag for the subsequent IDR picture, i.e., i4 in its slice header in the dec_ref_pic_marking( ) syntax. Here, PTS(b3)≦DTS(i4)<PTS(p3).

### Presentation Timeline Change=−1.

### CPB Change=−1.

6. Hierarchy original=1, Hierarchy spliced=0, Parity=Inconsistent—

TABLE 28

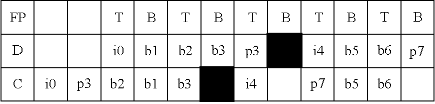

Splicer action:
1. Replicate the bits of top field p3 as a bottom field p3 as described previously herein.
2. DTS(replicated p3)=DTS(b3)+T_{field}.
3. DTS(p7) T DTS(i4)+2*T_{field}.

### Presentation Timeline Change=+1.

### CPB Change=+2.

This can alternatively be spliced as:

TABLE 29

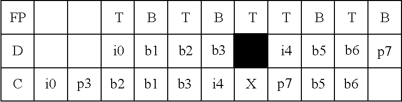

Splicer action:
1. Delete p3 by setting the no_output_of_prior_pics_flag for the subsequent IDR picture, i.e., i4 in its slice header in the dec_ref_pic_marking( ) syntax. Here, PTS(b3)≦DTS(i4)<PTS(p3).

### Presentation Timeline Change=−1.

### CPB Change=−1.

7. Hierarchy original=1, Hierarchy spliced=1, Parity=Consistent—

TABLE 30

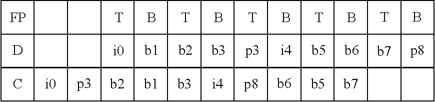

Splicer action: None.

### Presentation Timeline Change=0.

### CPB Change=0.

8. Hierarchy original=1, Hierarchy spliced=1, Parity=Inconsistent—

TABLE 31

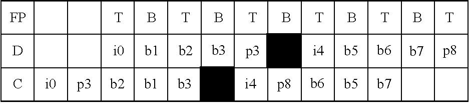

Splicer action:
1. Replicate the bits of top field p3 as a bottom field p3 as described previously herein.
2. DTS(replicated p3)=DTS(b3)+T_{field}.
3. DTS(i4)=DTS(replicated p3)+T_{field}.

### Presentation Timeline Change=+1.

### CPB Change=+1.

CPS and Presentation Timeline Changes Due to Splice in Followed by Splice Out—

1. Hierarchy original=0, Hierarchy spliced=0, Parity=Consistent:

Total Presentation Timeline Change=0.

Total CPB Change=0.

2. Hierarchy original=0, Hierarchy spliced=0, Parity=Inconsistent:

Total Presentation Timeline Change=+1+1=+2.

Total CPB Change=+1+1=+2.

3. Hierarchy original=0(1), Hierarchy spliced=1(0), Parity=Consistent:

Total Presentation Timeline Change=N+0(−1).

Total CPB Change=N+1(−1).

4. Hierarchy original=0(1), Hierarchy spliced=1(0), Parity=Inconsistent:

Total Presentation Timeline Change=N+1(−1).

Total CPB Change=N+2(−1).

5. Hierarchy original=1, Hierarchy spliced=1, Parity=Consistent:

Total Presentation Timeline Change=0.

Total CPB Change=0.

6. Hierarchy original=1, Hierarchy spliced=1, Parity=Inconsistent:

Total Presentation Timeline Change=+1+1=+2.

Total CPB Change=+1+1=+2.

Here, “N” denotes timing discussed below in “Remaining Splicing Cases Involving Non-Paired Field Sequences”.

Frame Sequence Followed by Spliced Non-Paired Field Sequence—

1. Hierarchy original=0, Hierarchy spliced=0, Parity=Consistent—

TABLE 32

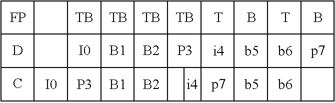

Splicer action:

1. DTS(i4)=DTS(B2)+T_{frame}+T_{field}.

### Presentation Timeline Change=+0.

### CPB Change=+1.

2. Hierarchy original=0, Hierarchy spliced=0, Parity=Inconsistent—

TABLE 33

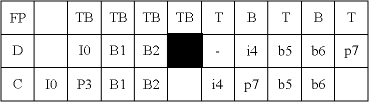

Splicer action:
1. Convert P3 to a 3 field picture that is TBT using pic_struct=5 in picture timing SEI of P3.
2. DTS(i4)=DTS(B2)+2*T_{frame}.

### Presentation Timeline Change=+1.

### CPB Change=+2.

This can alternatively be spliced as:

TABLE 34

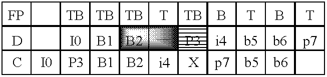

Splicer action:
1. Convert B2 to a 3 field picture that is TBT using pic_struct=5 in picture timing SEI of P3.
2. Delete P3 by setting the no_output_of_prior_pics_flag for the subsequent IDR picture, i.e., i4 in its slice header in the dec_ref_pic_marking( ) syntax. Here, PTS(b2)≦DTS(i4)<PTS(p3).
3. DTS(i4)=DTS(B2)+2*T_{frame}.

### Presentation Timeline Change=−1.

### CPB Change=−1.

3. Hierarchy original=0, Hierarchy spliced=1, Parity=Consistent—

TABLE 35

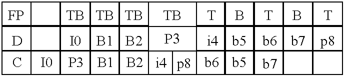

Splicer action: None.

### Presentation Timeline Change=0.

### CPB Change=0.

4. Hierarchy original=0, Hierarchy spliced=1, Parity=Inconsistent—

TABLE 36

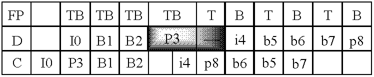

Splicer action:
1. Convert frame P3 to a 3 field picture that is TBT by using pic_struct=5 in picture timing SEI of P3.
2. DTS(i4)=DTS(B2)+T_{frame}+T_{field}.

### Presentation Timeline Change=+1.

### CPB Change=+1.

5. Hierarchy original=1, Hierarchy spliced=0, Parity=Consistent—

TABLE 37

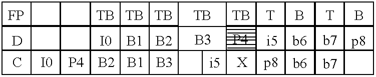

Splicer action:
1. Delete P4 by setting the no_output of_prior_pics_flag for the subsequent IDR picture, i.e., i5 in its slice header in the dec_ref_pic_marking( ). Here, PTS(B3)≦DTS(i5)<PTS(P4)
2. DTS(i5) DTS(B3) T_{frame}+T_{field}.

### Presentation Timeline Change=−2.

### CPB Change=−1.

This can alternatively be spliced as below:

TABLE 38

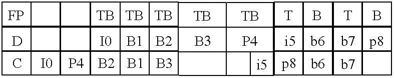

Splicer action:
1. DTS(i5)=DTS(B3)+2*T_{frame}+T_{field}.

### Presentation Timeline Change=+0.

### CPB Change=+3.

6. Hierarchy original=1, Hierarchy spliced=0, Parity=Inconsistent—

TABLE 39

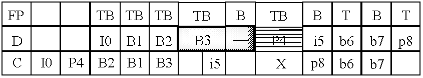

Splicer action:
1. Delete P4 by setting the no_output_of_prior_pics_flag for the subsequent IDR picture, i.e., i5 in its slice header in the dec_ref_pic_marking( ). Here, PTS(B3)≦DTS(i5)<PTS(P4).
2. Convert frame B3 to a 3 field picture that is TBT by using pic_struct=5 in picture timing SEI of B3.
3. DTS(i5)=DTS(B3)+T_{frame}+T_{field}.

### Presentation Timeline Change=−1.

### CPB Change=+0.

This can alternatively be spliced as below:

TABLE 40

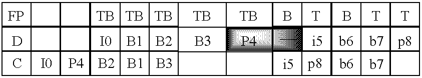

Splicer action:
1. Convert frame P4 to a 3 field picture that is TBT by using pic_struct=5 in picture timing SEI of P4.
2. DTS(i5)=DTS(B3)+3*T_{frame}.

### Presentation Timeline Change=+1.

### CPB Change=+4.

7. Hierarchy original=1, Hierarchy spliced=1, Parity=Consistent—

TABLE 41

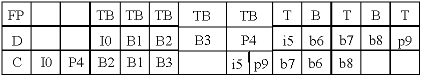

Splicer action:

1. DTS(i5)=DTS(B3)+2*T_{frame}.

### Presentation Timeline Change=+0.

### CPB Change=+2.

This can alternatively be spliced as below:

TABLE 42

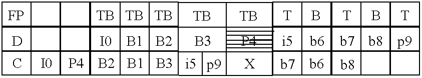

Splicer action:
1. Delete P4 by setting the no_output of_prior_pics_flag for the subsequent IDR picture, i.e., i5 in its slice header in the dec_ref_pic_marking( ). Here, PTS(B3)≦DTS(i5)<PTS(P4).

### Presentation Timeline Change=−2.

### CPB Change=−2.

8. Hierarchy original=1, Hierarchy spliced=1, Parity=Inconsistent—

TABLE 43

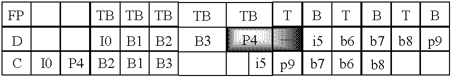

Splicer action:
1. Convert frame P4 to a 3 field picture that is TBT by using pic_struct=5 in picture timing SEI of P4.
2. DTS(i5)=DTS(B3)+2*T_{frame} T_{field}.

### Presentation Timeline Change=+1.

### CPB Change=+3.

This can alternatively be spliced as below:

TABLE 44

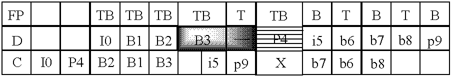

Splicer action:
1. Delete P4 by setting the no_output_of_prior_pics_flag for the subsequent IDR picture, i.e., i5 in its slice header in the dec_ref_pic_marking( ). Here, PTS(B3)≦DTS(i5)<PTS(P4).
2. Convert frame B3 to a 3 field picture that is TBT using pic_struct=5 in picture timing SEI of B3.
3. DTS(i5)=DTS(B3)+T_{frame}+T_{field}.

### Presentation Timeline Change=−1.

### CPB Change=−1.

Non-Paired Field Sequence Followed by Spliced Frame Sequence

1. Hierarchy original=0, Hierarchy spliced=0, Parity=Consistent—
See “Remaining Splicing Cases Involving Non-Paired Field Sequences” discussed subsequently herein.
2. Hierarchy original=0, Hierarchy spliced=0, Parity=Inconsistent—
See “Remaining Splicing Cases Involving Non-Paired Field Sequences” discussed subsequently herein.
3. Hierarchy original=0, Hierarchy spliced=1, Parity=Consistent—
See “Remaining Splicing Cases Involving Non-Paired Field Sequences” discussed subsequently herein.
4. Hierarchy original=0, Hierarchy spliced=1, Parity=Inconsistent—
See “Remaining Splicing Cases Involving Non-Paired Field Sequences” discussed subsequently herein.
5. Hierarchy original=1, Hierarchy spliced=0, Parity=Consistent—

TABLE 45

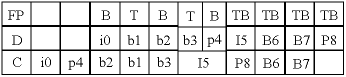

Splicer action: None.

### Presentation Timeline Change=0.

### CPB Change=0.

6. Hierarchy original=1, Hierarchy spliced=0, Parity=Inconsistent—

TABLE 46

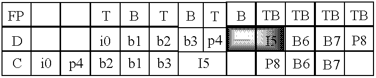

Splicer action:
1. Convert frame I5 to a 3 field picture that is BTB by using pic_struct=6 in picture timing SEI of I5.
2. DTS(P8)=DTS(I5)+T_{frame}+T_{field}.

### Presentation Timeline Change=+1.

### CPB Change=+1.

7. Hierarchy original=1, Hierarchy spliced=1, Parity=Consistent—

TABLE 47

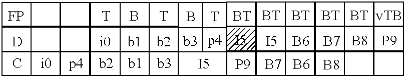

Splicer action:

1. Repeat frame I5 by using pic_struct=7 in picture timing SEI of I5.

### Presentation Timeline Change=+2.

### CPB Change=+0.

8. Hierarchy original=1, Hierarchy spliced=1, Parity=Inconsistent—

TABLE 48

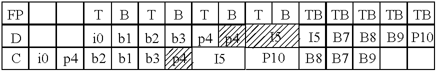

Splicer action:
1. Replicate the bits of p4 as a bottom field p4, as described previously herein.
2. Repeat frame I5 by using pic_struct=7 in picture timing SEI of I5.

### Presentation Timeline Change=+3.

### CPB Change=+3.

CPB and Presentation Timeline Changes Due to Splice in Followed by Splice Out—

1. Hierarchy original=0, Hierarchy spliced=0, Parity=Consistent:

Total Presentation Timeline Change=+0+N.

Total CPB Change=+1+N.

2. Hierarchy original=0, Hierarchy spliced=0, Parity=Inconsistent:

Total Presentation Timeline Change=+1(−1)+N.

Total CPB Change=+2(−1)+N.

3. Hierarchy original=0, Hierarchy spliced=1, Parity=Consistent:

Total Presentation Timeline Change=+0+0=0.

Total CPB Change=+0+0=0.

4. Hierarchy original=0, Hierarchy spliced=1, Parity=Inconsistent:

Total Presentation Timeline Change=+1+1=+2.

Total CPB Change=+1+1=+2.

5. Hierarchy original=1, Hierarchy spliced=0, Parity=Consistent:

Total Presentation Timeline Change=−2(+0)+N.

Total CPB Change=−1(−3)+N.

6. Hierarchy original=1, Hierarchy spliced=0, Parity=Inconsistent:

Total Presentation Timeline Change=−1(+1)+N.

Total CPB Change=+0(+4)+N.

7. Hierarchy original=1, Hierarchy spliced=1, Parity=Consistent:

Total Presentation Timeline Change=+0(−2)+2=+2(+0).

Total CPB Change=+2(−2)+0=+2(−2).

8. Hierarchy original=1, Hierarchy spliced=1, Parity=Inconsistent:

Total Presentation Timeline Change=+1(−1)+3=+4(+2).

Total CPB Change=+3(−1)+3=+6(+2).

Here, “N” denotes timing discussed below in “Remaining Splicing Cases Involving Non-Paired Field Sequences”.

Remaining Splicing Cases Involving Non-Paired Field Sequences—

The six “unsolved” cases listed in the discussion presented above require a different method. All of these cases involve a non-paired field sequence. In these situations, the latency of the non-paired field sequences is increased by changing the PTS of the pictures, because fields cannot be repeated by pic_struct field of the picture timing SEI. Consider the exemplary sequence below.

TABLE 49

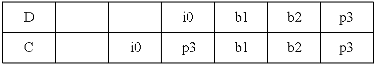

The latency can be changed by one by PTS(i0)=PTS(i0)+T_{field}. The same operation is performed for b1, b2, and p3.

TABLE 50

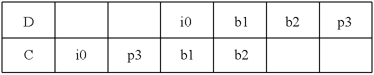

Non-Paired Field Sequence followed by Spliced Non-Paired Field—

1. Hierarchy original=0, Hierarchy spliced=1, Parity=Consistent.

TABLE 51

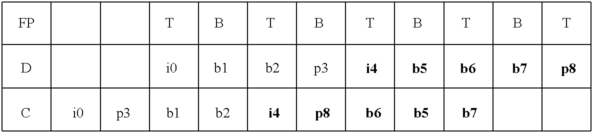

Splicer action: None.

### Presentation Timeline Change=0.

### CPB Change=0.

2. Hierarchy original=0, Hierarchy spliced=1, Parity=Inconsistent.

TABLE 52

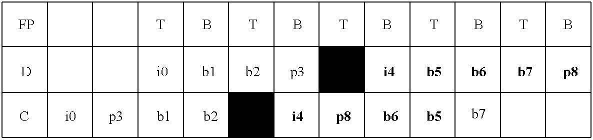

Splicer action:

Replicate the bits of bottom field p3 as a top field p3 as described previously herein.

DTS(replicated p3)=DTS(b2)+T_{field}.

DTS(i4)=DTS(replicated p3) T_{field}.

### Presentation Timeline Change=+1.

### CPB Change=+1.

Non-Paired Field Sequence followed by Spliced Frame—

1. Hierarchy original=0, Hierarchy spliced=0, Parity=Consistent.

TABLE 53

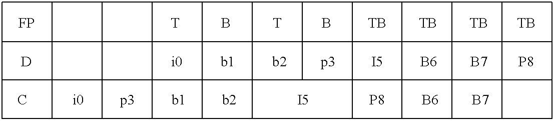

Splicer action: None.

### Presentation Timeline Change=0.

### CPB Change=0.

2. Hierarchy original=0, Hierarchy spliced=0, Parity=Inconsistent.

TABLE 54

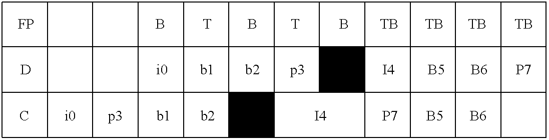

Splicer action:

Replicate the bits of top field p3 as a bottom field p3 as described previously herein.

DTS(replicated p3)=DTS(b2)+T_{field}.

DTS(I4)=DTS(replicated p3)+T_{field}.

### Presentation Timeline Change=+1.

### CPB Change=+1.

3. Hierarchy original=0, Hierarchy spliced=1, Parity=Consistent.

TABLE 55

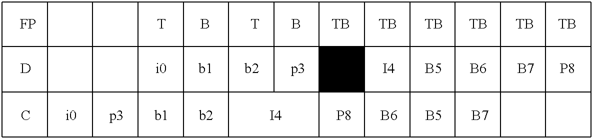

Splicer action:

1. Repeat I4 by using pic_struct=7 in picture timing SEI of I4.

### Presentation Timeline Change=+2.

### CPB Change=+0.

4. Hierarchy original=0, Hierarchy spliced=1, Parity=Inconsistent.

TABLE 56

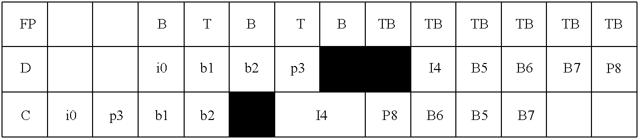

Splicer action:
1. Replicate the bits of top field p3 as a bottom field p3 as described previously herein.
2. Repeat I4 by using pic_struct=7 in picture timing SEI of I4.

### Presentation Timeline Change=+3.

### CPB Change=+1.

Complementary Field Sequence Followed by Spliced Complementary Field Sequence—

1. Hierarchy original=0, Hierarchy spliced=0, Parity=Consistent—

TABLE 57

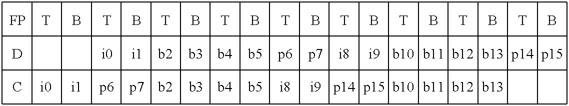

Splicer action: None.

### Presentation Timeline Change=0.

### CPB Change=0.

2. Hierarchy original=0, Hierarchy spliced=0, Parity=Inconsistent—

TABLE 58

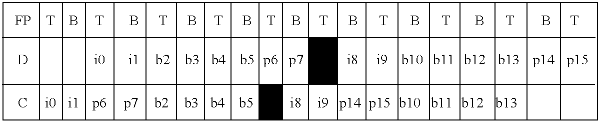

Splicer action:

1. Replicate the bits of bottom field p7 as a non-paired top field p7.

### Presentation Timeline Change=+1.

### CPB Change=+1.

3. Hierarchy original=0, Hierarchy spliced=1, Parity=Consistent—

TABLE 59

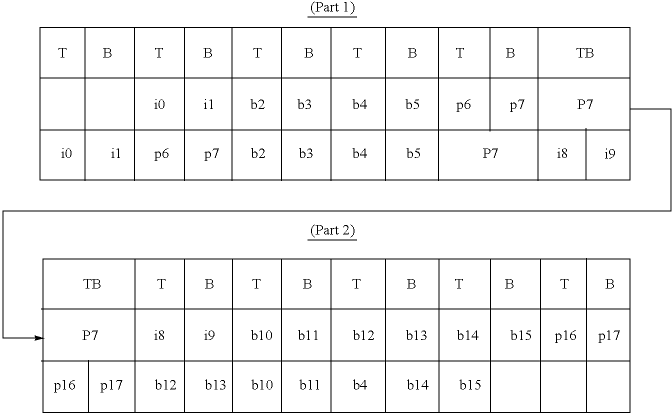

Splicer action:

1. Replicate the bits of field pair p6 and p7 as a frame picture P7.

2. Repeat frame P7 by using pic_struct=7 in picture timing SEI of P7.

### Presentation Timeline Change=+4.

### CPB Change=+2.

4. Hierarchy original=0, Hierarchy spliced=1, Parity=Inconsistent—

TABLE 60

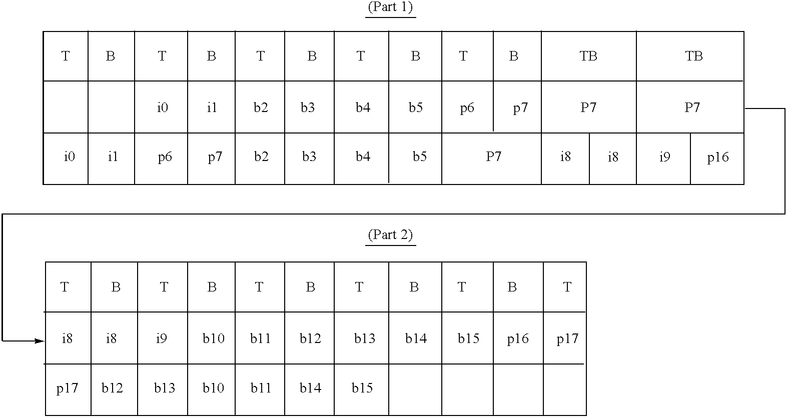

Splicer action:

1. Replicate the bits of field pair p6 and p7 as a frame picture P7.

2. Repeat frame P7 by using pic_struct=7 in picture timing SEI of P7.

3. Replicate the bits of bottom field i8 as a top field i8.

### Presentation Timeline Change=+5.

### CPB Change=+3.

5. Hierarchy original=1, Hierarchy spliced=0, Parity=Consistent—

TABLE 61

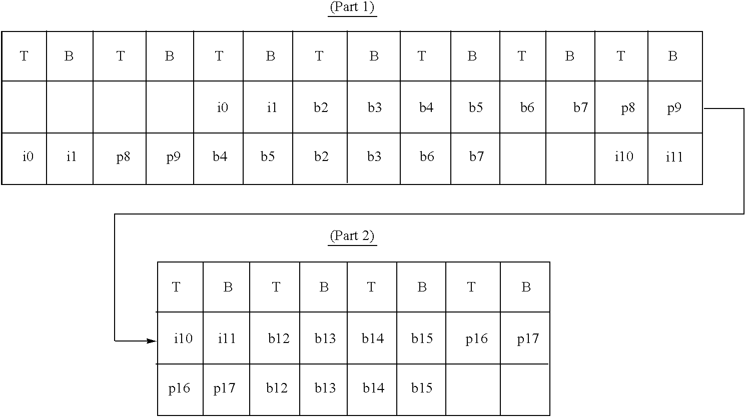

Splicer action:

1. DTS(i10)=DTS(b7)+3*T_{field}.

### Presentation Timeline Change=+0.

### CPB Change=+2.

6. Hierarchy original=1, Hierarchy spliced=0, Parity=Inconsistent—

TABLE 62

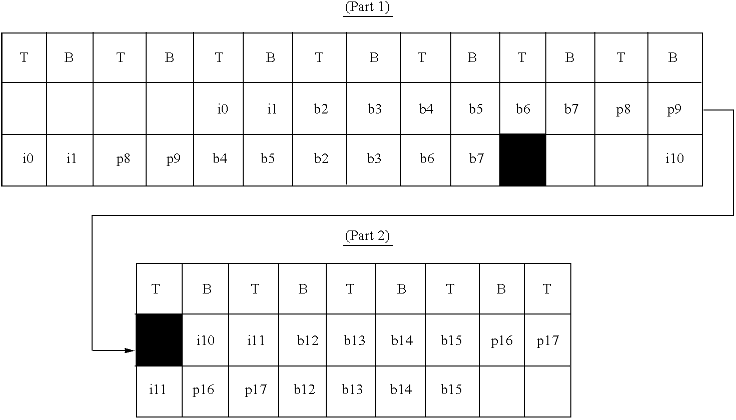

Splicer action:

1. Replicate the bits of bottom field p9 as a non-paired top field p9.

2. DTS(p9)=DTS(b7) T_{field}.

3. DTS(i10)=DTS(b7)+4*T_{field}.

### Presentation Timeline Change=+1.

### CPB Change=+3.

7. Hierarchy original=1, Hierarchy spliced=1, Parity=Consistent—

TABLE 63

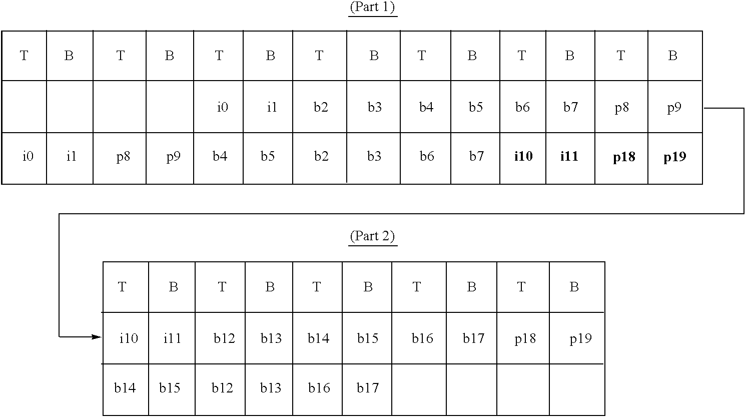

Splicer action: None.

### Presentation Timeline Change=0.

### CPB Change=0.

8. Hierarchy original=1, Hierarchy spliced=1, Parity=Inconsistent—

TABLE 64

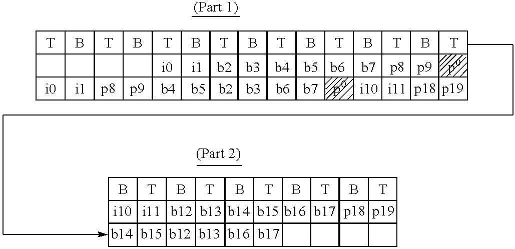

Splicer action:

1. Replicate the bits of bottom field p9 as a non-paired top field p9.

2. DTS(p9)=DTS(b7)+T_{field}.

3. DTS(i10)=DTS(b7)+T_{field}.

### Presentation Timeline Change=+1.

### CPB Change=+1.

CPB and Presentation Timeline Changes Due to Splice in Followed by Splice Out—

1. Hierarchy original=0, Hierarchy spliced=0, Parity=Consistent:

Total Presentation Timeline Change=0.

Total CPB Change=0.

2. Hierarchy original=0, Hierarchy spliced=0, Parity=Inconsistent:

Total Presentation Timeline Change=+1+1=+2.

Total CPB Change=+1+1=+2.

3. Hierarchy original=0(1), Hierarchy spliced=1(0), Parity=Consistent:

Total Presentation Timeline Change=+4+0=+4.

Total CPB Change=+2+2+4.

4. Hierarchy original=0(1), Hierarchy spliced=1(0), Parity=Inconsistent:

Total Presentation Timeline Change=+5+1=+6.

Total CPB Change=+3+3=+6.

5. Hierarchy original=1, Hierarchy spliced=1, Parity=Consistent:

Total Presentation Timeline Change=0.

Total CPB Change=0.

6. Hierarchy original=1, Hierarchy spliced=1, Parity=Inconsistent:

Total Presentation Timeline Change=+1+1=+2.

Total CPB Change=+1+1=+2.

Frame Sequence Followed by Spliced Complementary Field Sequence—

1. Hierarchy original=0, Hierarchy spliced=0, Parity=Consistent—

TABLE 65

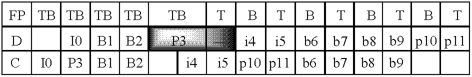

Splicer action: None.

### Presentation Timeline Change=+0.

### CPB Change=+0.

2. Hierarchy original=0, Hierarchy spliced=0, Parity=Inconsistent—

TABLE 66

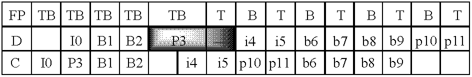

Splicer action:
1. Convert frame P3 to a 3 field picture that is TBT by using pic_struct=5 in picture timing SEI of P3.
2. DTS(i4)=DTS(B2)+T_{frame}+T_{field}.

### Presentation Timeline Change=+1.

### CPB Change=+1.

3. Hierarchy original=0, Hierarchy spliced=1, Parity=Consistent—

TABLE 67

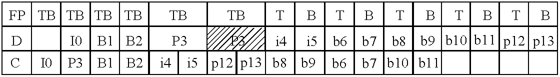

Splicer action:

1. Repeat P3 by using pic_struct=7 in picture timing SEI of P3.

### Presentation Timeline Change=+2.

### CPB Change=+0.

4. Hierarchy original=0, Hierarchy spliced=1, Parity=Inconsistent—

TABLE 68

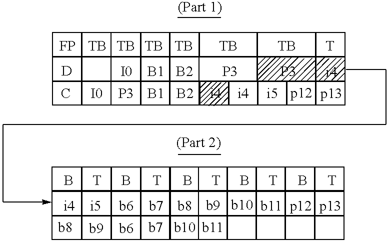

Splicer action:

1. Repeat P3 by using pic_struct=7 in picture timing SEI of P3.

2. Replicate the bits of bottom field i4 as a non-paired top field i4.

### Presentation Timeline Change=+3.

### CPB Change=+1.

5. Hierarchy original=1, Hierarchy spliced=0, Parity=Consistent—

TABLE 69

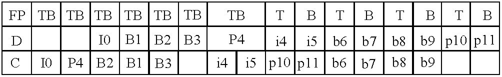

Splicer action:

1. DTS(i4)=DTS(B3)+2*T_{frame}.

### Presentation Timeline Change=+0.

### CPB Change=+2.

This can alternatively be spliced as:

TABLE 70

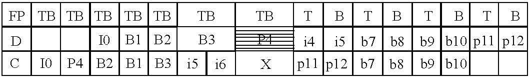

Splicer action:
1. Delete P4 by setting the no_output_of_prior_pics_flag for the subsequent IDR picture, i.e., i5 in its slice header in the dec_ref_pic_marking( ).

### Presentation Timeline Change=−2.

### CPB Change=−2.

6. Hierarchy original=1, Hierarchy spliced=0, Parity=Inconsistent—

TABLE 71

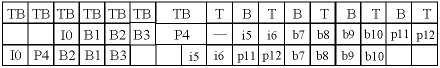

Splicer action:
1. Convert P4 to a 3 field picture that is TBT using pic_struct=5 in picture timing SEI of P4.
2. DTS(i5)=DTS(B3)+2*T_{frame}+T_{field}.

### Presentation Timeline Change=+1.

### CPB Change=+3.

This can alternatively be spliced as:

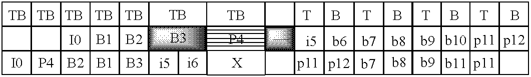

Splicer action:
1. Delete P4 by setting the no_output_of_prior_pics_flag for the subsequent IDR picture, i.e., i5 in its slice header in the dec_ref_pic_marking( ) syntax.
2. DTS(p11)=DTS(i6)+2*T_{field}.

### Presentation Timeline Change=−1.

### CPB Change=−1.

7. Hierarchy original=1, Hierarchy spliced=1, Parity=Consistent—

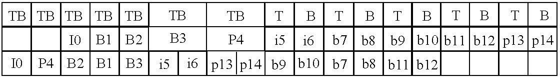

Splicer action: None.

### Presentation Timeline Change=0.

### CPB Change=0.

8. Hierarchy original=1, Hierarchy spliced=1, Parity=Inconsistent—

TABLE 74

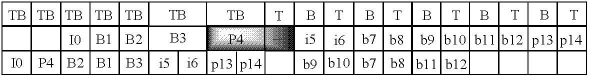

Splicer action:
1. Convert P4 to a 3 field picture that is TBT using pic_struct=5 in picture timing SEI of P4.
2. DTS(b9)=DTS(p14)+2*T_{field}.

### Presentation Timeline Change=+1.

### CPB Change=+1.

Complementary Field Sequence Followed by Spliced Frame Sequence—

1. Hierarchy original=0, Hierarchy spliced=0, Parity=Consistent—

TABLE 75

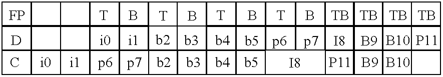

Splicer action: None.

### Presentation Timeline Change=0.

### CPB Change=0.

2. Hierarchy original=0, Hierarchy spliced=0, Parity=Inconsistent—

TABLE 76

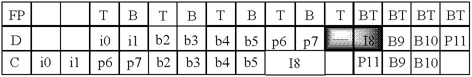

Splicer action:
1. Convert I8 to a 3 field picture that is TBT using pic_struct=5 in picture timing SEI of P4.
2. DTS(P11)=DTS(I8)+T_{frame}+T_{field}.

### Presentation Timeline Change=+1.

### CPB Change=+1.

3. Hierarchy original=0, Hierarchy spliced=1, Parity=Consistent—

TABLE 77

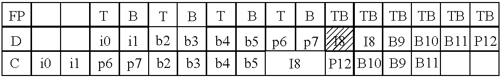

Splicer action:

1. Repeat frame I8 by using pic_struct=7 in picture timing SEI of I8.

### Presentation Timeline Change=+2.

### CPB Change=+0.

4. Hierarchy original=0, Hierarchy spliced=1, Parity=Inconsistent—

TABLE 78

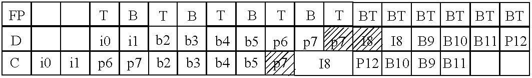

Splicer action:

1. Replicate the bits of bottom field p7 as a non-paired top field p7.

2. Repeat frame I8 by using pic_struct=7 in picture timing SEI of I8.

### Presentation Timeline Change=+3.

### CPB Change=+1.

5. Hierarchy original=1, Hierarchy spliced=0, Parity=Consistent—

TABLE 79

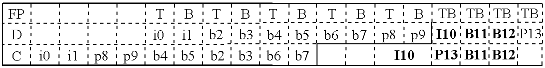

Splicer action:

1. DTS(I10)=DTS(b7)+3*T_{field}.

### Presentation Timeline Change=+0.

### CPB Change=+2.

6. Hierarchy original=1, Hierarchy spliced=0, Parity=Inconsistent—

TABLE 80

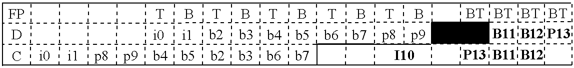

Splicer action:
1. Convert I10 to a 3 field picture that is TBT using pic_struct=5 in picture timing SEI of I10.
2. DTS(I10)=DTS(b7)+3*T_{field}.
3. DTS(P13)=DTS(I10)+T_{frame}+T_{field}.

### Presentation Timeline Change=+1.

### CPB Change=+3.

7. Hierarchy original=1, Hierarchy spliced=1, Parity=Consistent—

TABLE 81

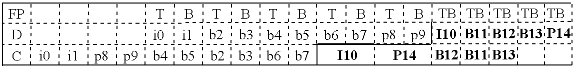

Splicer action: None.

### Presentation Timeline Change=

### CPB Change=0.

8. Hierarchy original=1, Hierarchy spliced=1, Parity=Inconsistent—

TABLE 82

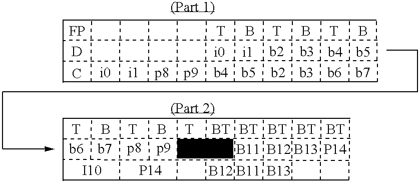

Splicer action:
1. Convert I10 to a 3 field picture that is TBT using pic_struct=5 in picture timing SEI of I10.
2. DTS(B12)=DTS(P14) T_{frame} T_{field}.

### Presentation Timeline Change=+3.

### CPB Change=+3.

CPB and Presentation Timeline Changes Due to Splice in Followed by Splice Out—

1. Hierarchy original=0, Hierarchy spliced=0, Parity=Consistent:

Total Presentation Timeline Change=+0+0=0.

Total CPB Change=+0+0=0.

2. Hierarchy original=0, Hierarchy spliced=0, Parity=Inconsistent:

Total Presentation Timeline Change=+1+1=+2.

Total CPB Change=+1+1=+2.

3. Hierarchy original=0, Hierarchy spliced=1, Parity=Consistent:

Total Presentation Timeline Change=+2+0=+2.

Total CPB Change=+0+2=+2.

4. Hierarchy original=0, Hierarchy spliced=1, Parity=Inconsistent:

Total Presentation Timeline Change=+3+1=+4.

Total CPB Change=+1+3=+4.

5. Hierarchy original=1, Hierarchy spliced=0, Parity=Consistent:

Total Presentation Timeline Change=+0(−2)+2=+2(+0).

Total CPB Change=+2(−2)+0=+2(−2).

6. Hierarchy original=1, Hierarchy spliced=0, Parity=Inconsistent:

Total Presentation Timeline Change=+1(−1)+3=+4(+2).

Total CPB Change=+3(−1)+1=+4(+0).

7. Hierarchy original=1, Hierarchy spliced=1, Parity=Consistent:

Total Presentation Timeline Change=+0+0=0.

Total CPB Change=+0+0=0.

8. Hierarchy original=1, Hierarchy spliced=1, Parity=Inconsistent:

Total Presentation Timeline Change=+1+3=+4.

Total CPB Change=+1+3=+4.

Pull Down—

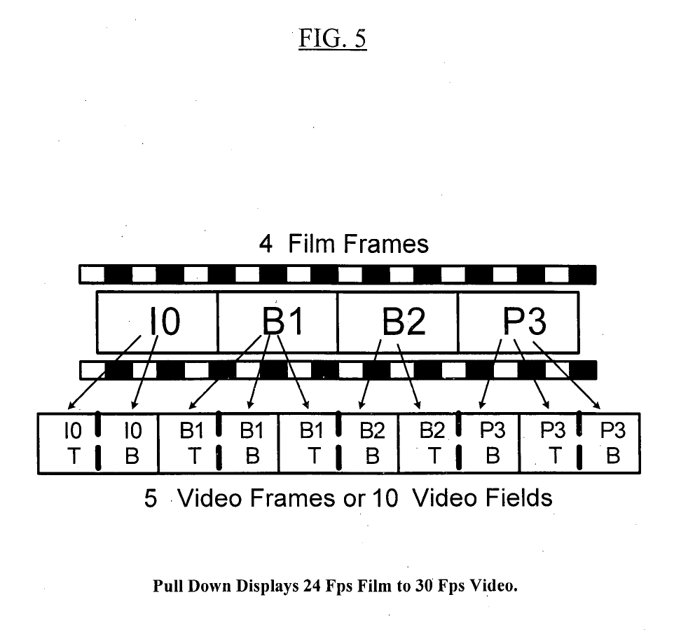

Film sequences which are coded to display at 24 frames per second (fps) when displayed as interlaced video at 30 fps, a 2-3 pull down method is used, as shown in the exemplary embodiment of FIG. 5.

Here, each film frame can be displayed as a top (T) or bottom (B) frame of interlaced video. Furthermore, each film frame can be displayed as two or three fields in various field combinations TB, BT, TBT, or BTB. The field parity for display is stored in the pic_struct field of the picture timing SEI of each film frame. These are:

1. pic_struct=3 is TB.

2. pic_struct=4 is BT.

3. pic_struct=5 is TBT.

4. pic_struct=6 is BTB.

The splicing process also considers the field parity consistency. Four specific cases are discussed below:
1. Splicing a 2-3 pull down video with 2-3 pull down original with field parity consistent.
2. Splicing a 2-3 pull down video with 2-3 pull down original with field parity inconsistent.
3. Splicing a 2-3 pull down video with normal interlaced video with field parity consistent.
4. Splicing a 2-3 pull down video with normal interlaced video with field parity inconsistent.
   There can be many more cases involving field and frame pictures than those listed above. However, the four cases listed above illustrate the general principles, and can readily be extended by those of ordinary skill given the present disclosure, including the exhaustive listing of cases discussed previously herein.
1. Original=2-3 Pull down, Spliced=2-3 Pull down, Parity=Consistent—

TABLE 83

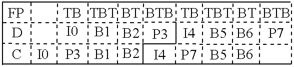

Splicer action: None.

### Presentation Timeline Change=

### CPB Change=0.

2. Original=2-3 Pull down, Spliced=2-3 Pull down, Parity=Inconsistent—

TABLE 84

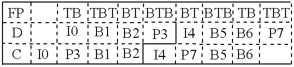

Splicer action:

Delete the last bottom field of P3 by changing the pic_struct to 4 from 6.

### Presentation Timeline Change=−1.

### CPB Change=−0.

3. Original=2-3 Pull down, Spliced=Normal Video, Parity=Consistent

TABLE 85

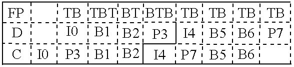

Splicer action: None.

### Presentation Timeline Change=0.

### CPB Change=0.

4. Original=2-3 Pull down, Spliced=Normal Video, Parity=Inconsistent—

TABLE 86

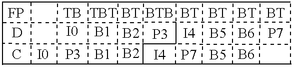

Splicer action:

1. Delete the last bottom field of P3 by changing the pic_struct to 4 from 6.

### Presentation Timeline Change=−1.

### CPB Change=+0.

Two Layer B-Hierarchy—

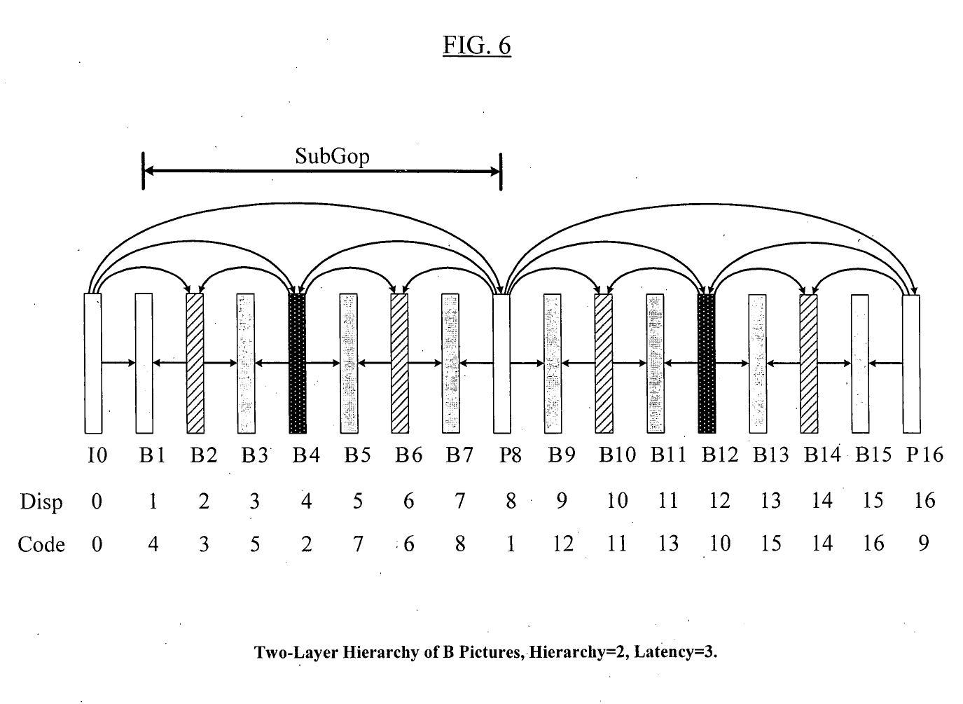

All discussions presented above can be extended to higher layers of hierarchy of B pictures, such as a two-layer hierarchy. FIG. 6 herein shows an exemplary two-layer hierarchy of B pictures according to the invention, which is now further described.

TABLE 87

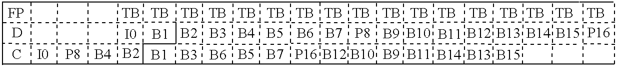

In Table 87 above, the anchor or reference or stored B pictures are shown in italics. A few exemplary splicing cases are now considered for purposes of illustration.
1. Hierarchy original=2, Hierarchy spliced=1, Parity=Consistent—

TABLE 88

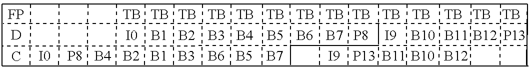

Splicer action:

1. DTS(P9)=DTS(B7)+T_{frame}.

### Presentation Timeline Change=+0.

### CPB Change=+2.

2. Hierarchy original=2, Hierarchy spliced=0, Parity=Consistent—

TABLE 89

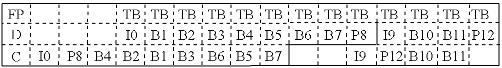

Splicer action:

1. DTS(P9)=DTS(B7)+3*T_{frame}.

### Presentation Timeline Change=+0.

### CPB Change=+4.

Alternatively, this can be spliced as follows:

TABLE 90

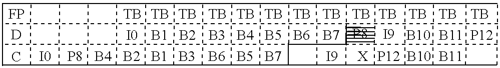

Splicer action:
1. Delete P8 by setting the no_output_of_prior_pics_flag for the subsequent IDR picture, i.e., I9 in its slice header in the dec_ref_pic_marking( ) syntax.
2. DTS(I9)=DTS(B7)+2*T_{frame}.

### Presentation Timeline Change=−2.

### CPB Change=+0.

3. Hierarchy original=1, Hierarchy spliced=2, Parity=Consistent—

TABLE 91

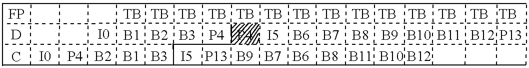

Splicer action:

1. Repeat P4 by using pic_struct=7 in picture timing SEI of P4.

### Presentation Timeline Change=+2.

### CPB Change=+0.

4. Hierarchy original=0, Hierarchy spliced=2, Parity=Consistent—

TABLE 92

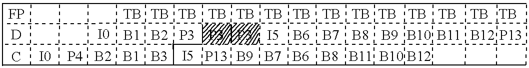

Splicer action:

1. Repeat P3 twice by using pic_struct=8 in picture timing SEI of P3.

### Presentation Timeline Change=+4.

### CPB Change=+0.

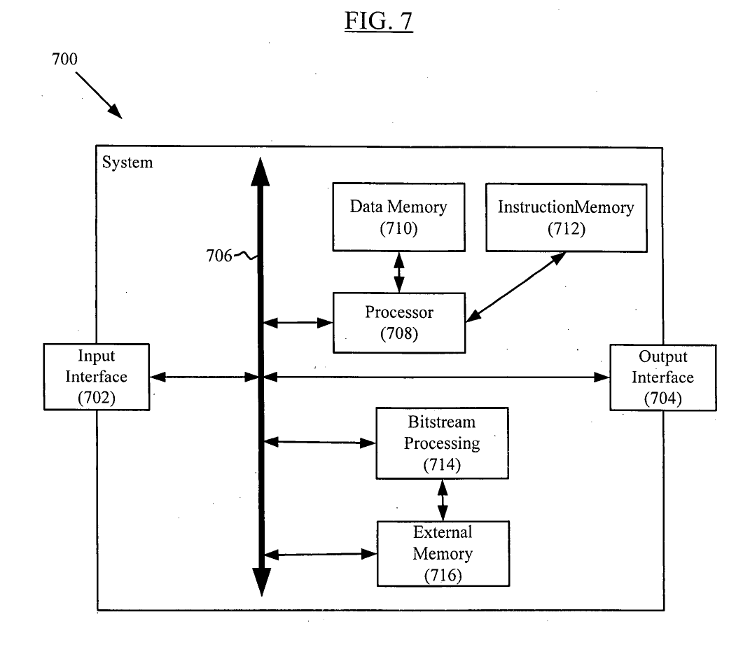

FIG. 7 shows an exemplary system-level apparatus 700, where one or more of the various image/video splicing and transcoding/transrating apparatus of the present invention are implemented, such as by using a combination of hardware, firmware and/or software. This embodiment of the system 700 comprises an input interface 702 adapted to receive one or more video bitstreams, and an output interface 704 adapted to output a one or more transrated output bitstreams. The interfaces 702 and 704 may be embodied in the same physical interface (e.g., RJ-45 Ethernet interface, PCI/PIC-x bus, IEEE-Std. 1394 “FireWire”, USB, wireless interface such as PAN, WiFi (IEEE Std. 802.11, WiMAX (IEEE Std. 802.16), etc.). The video bitstream made available from the input interface 702 may be carried using an internal data bus 706 to various other implementation modules such as a processor 708 (e.g., DSP, RISC, CISC, array processor, etc.) having a data memory 710 an instruction memory 712, a bitstream processing module 714, and/or an external memory module 716 comprising computer-readable memory. In one embodiment, the bitstream processing module 714 is implemented in a field programmable gate array (FPGA). In another embodiment, the module 714 (and in fact the entire device 700) may be implemented in a system-on-chip (SoC) integrated circuit, whether on a single die or multiple die. The device 700 may also be implemented using board level integrated or discrete components. Any number of other different implementations will be recognized by those of ordinary skill in the hardware/firmware/software design arts, given the present disclosure, all such implementations being within the scope of the claims appended hereto.

In one exemplary software implementation, the present invention may be implemented as a computer program that is stored on a computer useable medium, such as a memory card, a digital versatile disk (DVD), a compact disc (CD) and the like, that includes a computer readable program which when loaded on a computer implements the methods of the present invention.

It would be recognized by those skilled in the art, that the invention described herein can take the form of an entirely hardware embodiment, an entirely software embodiment, or an embodiment containing both hardware and software elements. In an exemplary embodiment, the invention may be implemented in software, which includes but is not limited to firmware, resident software, microcode, etc.

In this case, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

It should be understood, of course, that the foregoing relates to exemplary embodiments of the invention and that modifications may be made without departing from the spirit and scope of the invention as set forth in the following claims.

### APPENDIX I

### List of Abbreviations

Consider the sequence below in display and coding order for the definitions below:

TABLE III-1
Example Sequence in Display and Coding Order.

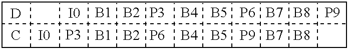

PTS=presentation time stamp, time at which a picture is displayed instantaneously.
DTS=decode time stamp, time at which a picture is decoded.
Picture=field or frame.
Display order (D)=order in which pictures are displayed, top line in above figure.
Coding order (C)=order in which pictures are encoded, also the order in which pictures are decoded, bottom line in above figure.
Iₙ, Bₙ, Pₙ=I, B or P frames respectively whose sequence number in display order is n.
iₙ, bₙ, pₙ=I, B or P fields respectively whose sequence number in display order is n. Note that we use upper case letters to denote frame pictures, and lower case letters to denote field pictures.
T_{pic}=time needed to decode or display a picture that is either field or frame.
(DPB) Latency=given a sequence that starts with an I/IDR picture, we define latency as the time in picture units that it takes us to reorder/display after decoding (PTS(I) DTS(I)−DTS(I)/T_{pic}, where T_{pic} is field time if we have an I field and frame time if have an I frame.
SubGop=Sequence of B pictures terminated by a P or I in display order.
Hierarchical B Picture=A GOP structure where B picture in a SubGop that is used as a reference for the neighboring B pictures.

### APPENDIX II

Picture timing SEI message syntax

| pic_timing( payloadSize ) { | C | Descriptor |
|---|---|---|
| if( CpbDpbDelaysPresentFlag ) { | | |
| cpb_removal_delay | 5 | u(v) |
| dpb_output_delay | 5 | u(v) |
| } | | |
| if( pic_struct_present_flag ) { | | |
| pic_struct | 5 | u(4) |
| for( i = 0; i < NumClockTS ; i++ ) { | | |
| clock_timestamp_flag[i] | 5 | u(1) |
| if( clock_timestamp_flag[i] ) { | | |
| ct_type | 5 | u(2) |
| nuit_field_based_flag | 5 | u(1) |
| counting_type | 5 | u(5) |
| full_timestamp_flag | 5 | u(1) |
| discontinuity_flag | 5 | u(1) |
| cnt_dropped_flag | 5 | u(1) |
| n_frames | 5 | u(8) |
| if( full_timestamp_flag ) { | | |
| seconds_value /* 0..59 */ | 5 | u(6) |
| minutes_value /* 0..59 */ | 5 | u(6) |
| hours_value /* 0..23 */ | 5 | u(5) |
| } else { | | |
| seconds_flag | 5 | u(1) |
| if( seconds_flag ) { | | |
| seconds_value /* range 0..59 */ | 5 | u(6) |
| minutes_flag | 5 | u(1) |
| if( minutes_flag ) { | | |
| minutes_value /* 0..59 */ | 5 | u(6) |
| hours_flag | 5 | u(1) |
| if( hours_flag ) | | |
| hours_value /* 0..23 */ | 5 | u(5) |
| } | | |
| } | | |
| } | | |
| if( time_offset_length > 0 ) | | |
| time_offset | 5 | i(v) |
| } | | |
| } | | |
| } | | |
| } | | |

### APPENDIX III

### Picture Timing SEI Message Semantics

pic_struct indicates whether a picture should be displayed as a frame or one or more fields, according to Table III-1. Frame doubling (pic_struct equal to 7) indicates that the frame should be displayed two times consecutively, and frame tripling (pic_struct equal to 8) indicates that the frame should be displayed three times consecutively.
NOTE—Frame doubling can facilitate the display, for example, of 25 p video on a 50 p display and 29.97 p video on a 59.94 p display. Using frame doubling and frame tripling in combination on every other frame can facilitate the display of 23.98 p video on a 59.94 p display.

TABLE III-1
Interpretation of pic_struct

| Value | Indicated display of picture | Restrictions | NumClockTS |
|---|---|---|---|
| 0 | frame | field_pic_flag shall be 0 | 1 |
| 1 | top field | field_pic_flag shall be 1, | 1 |
| | | bottom_field_flag shall be 0 | |
| 2 | bottom field | field_pic_flag shall be 1, | 1 |
| | | bottom_field_flag shall be 1 | |
| 3 | top field, bottom field, in that order | field_pic_flag shall be 0 | 2 |
| 4 | bottom field, top field, in that order | field_pic_flag shall be 0 | 2 |
| 5 | top field, bottom field, top field | field_pic_flag shall be 0 | 3 |
| | repeated, in that order | | |
| 6 | bottom field, top field, bottom field | field_pic_flag shall be 0 | 3 |
| | repeated, in that order | | |
| 7 | frame doubling | field_pic_flag shall be 0 | 2 |
| | | fixed_frame_rate_flag shall be 1 | |
| 8 | frame tripling | field_pic_flag shall be 0 | 3 |
| | | fixed_frame_rate_flag shall be 1 | |
| 9 . . . 15 | reserved | | |

NumClockTS is determined by pic_struct as specified in Table III-1. There are up to NumClockTS sets of clock timestamp information for a picture, as specified by clock timestamp_flag[i] for each set. The sets of clock timestamp information apply to the field(s) or the frame(s) associated with the picture by pic_struct.

The contents of the clock timestamp syntax elements indicate a time of origin, capture, or alternative ideal display. This indicated time is computed as

clockTimestamp=((hH*60+mM)*60+sS)*time_scale+nFrames*(num_units_in_tick*(1+nuit_field_based_flag))+tOffset, (III-1)

in units of clock ticks of a clock with clock frequency equal to time_scale Hz, relative to some unspecified point in time for which clockTimestamp is equal to 0. Output order and DPB output timing are not affected by the value of clockTimestamp. When two or more frames with pic_struct equal to 0 are consecutive in output order and have equal values of clockTimestamp, the indication is that the frames represent the same content and that the last such frame in output order is the preferred representation.
NOTE—clockTimestamp time indications may aid display on devices with refresh rates other than those well-matched to DPB output times.

What is claimed:

1. A video splicing method, comprising:
providing a first video stream comprising hierarchical B pictures;
providing a second video stream comprising no hierarchical B pictures;
identifying a splicing boundary;
splicing the first and second streams at the boundary to produce a spliced stream; and
applying a correction to the spliced stream.

2. The method of claim 1, wherein the act of identifying is performed so as to maintain compliance with H.264 protocol requirements.

3. The method of claim 1, wherein the act of identifying is performed based at least in part on frame type.

4. The method of claim 3, wherein the frame type is selected from the group consisting of: (i) I-frames; and (ii) P-frames.

5. The method of claim 3, wherein the act of splicing comprises splicing in the second stream at an I-frame or P-frame of the first stream.

6. The method of claim 1, further comprising evaluating field parity.

7. The method of claim 6, wherein the act of evaluating parity comprises evaluating whether a frame corresponds to a top field or bottom field associated with an interlaced video stream.

8. The method of claim 7, further comprising adjusting said splicing boundary based at least in part on said act of evaluating parity.

9. The method of claim 1, wherein the act of applying a correction comprises duplication of a frame.

10. The method of claim 1, wherein the act of applying a correction comprises deleting a frame.

11. The method of claim 1, further comprising throttling a bitrate associated with the spliced stream to as to avoid overflow or underflow conditions.

12. Video splicing apparatus, comprising:
first apparatus adapted to receive a first video stream comprising hierarchical B pictures;
second apparatus adapted to receive a second video stream comprising no hierarchic B pictures;
logic in communication with said first and second apparatus, said logic configured to identify a splicing boundary within at least one of said first and second streams;
a splicer configured to splice the first and second streams at the boundary; and
logic configured to apply a correction.

13. The apparatus of claim 12, wherein the logic configured to identify is configured to maintain compliance with H.264 protocol requirements.

14. The apparatus of claim 12, wherein the logic configured to identify is configured to identify based at least in part on frame type.

15. The apparatus of claim 14, wherein the frame type is selected from the group consisting of (i) I-frames; and (ii) P-frames.

16. The apparatus of claim 14, wherein the splicer comprises logic adapted to splice in said second stream at an I-frame or P-frame of said first stream.

17. The apparatus of claim 12, further comprising logic in communication with the splicer and configured to evaluate field parity.

18. The apparatus of claim 17, wherein said evaluation of parity comprises an evaluation of whether a frame corresponds to a top field or bottom field associated with an interlaced video stream.

19. The apparatus of claim 18, further comprising logic in communication with the splicer and configured to adjust said splicing boundary based at least in part on said evaluation of parity.

20. The apparatus of claim 12, further comprising logic adapted to apply a correction via duplication of a frame.

21. The apparatus of claim 12, further comprising logic adapted to apply a correction via deletion of a frame.

22. The apparatus of claim 12, further comprising apparatus configured to throttle a bitrate associated with the spliced stream to as to avoid overflow or underflow conditions.

23. The apparatus of claim 22, wherein the apparatus configured to throttle comprises first and second picture buffers.

24. The apparatus of claim 23, wherein at least one of said buffers is configured to be emptied at a substantially constant rate specified by a presentation timeline.

25. The apparatus of claim 12, wherein the video splicing apparatus comprises a processor and at least one computer program adapted to run thereon, the at least one computer program comprising at least: (i) said logic configured to identify a splicing boundary within at least one of said first and second streams; (ii) said splicer; and (iii) said logic configured to apply a correction.

26. Computer readable apparatus comprising a storage medium, the medium adapted to store at least one computer program, the at least one computer program being configured to, when executed on a processing device:
receive a first video stream comprising a first type of picture, the first type having a first form of dependency relating to frame type;
receive a second video stream comprising a second type of picture, the second type having a second form of dependency relating to frame type different than the first form;
identify a splicing boundary within the first stream;
splice the second stream into the first at the boundary to produce a spliced stream; and
determine whether a correction is required and if so, apply a correction.

27. A video splicing method, comprising:
providing a first video stream encoded according to the H.264 standard and comprising a first plurality of coding parameters;
providing a second video stream encoded according to the H.264 standard and comprising a second plurality of coding parameters, the second plurality of parameters being different from the first plurality of parameters in at least one regard;
identifying a splicing boundary; and
splicing the first and second streams at the boundary to produce a spliced stream.
